(19) United States
(12) Patent Application Publication
(10) Pub. No.: US 2008/0288312 A1
(43) Pub. Date: Nov. 20, 2008

(54) GENERATING SUFFICIENTLY SIZED, RELATIVELY HOMOGENEOUS SEGMENTS OF REAL PROPERTY TRANSACTIONS BY CLUSTERING BASE GEOGRAPHICAL UNITS

(75) Inventors: Eric L. Miles, Castle Rock, CO (US); Carl A. Cozine, Denver, CO (US); Bradley D. Brown, Littleton, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignees: INTELLIREAL, LLC.; A Colorado Limited Liability Company

(21) Appl. No.: 12/121,477

(22) Filed: May 15, 2008

Related U.S. Application Data
(60) Provisional application No. 60/917,948, filed on May 15, 2007.

(51) Int. Cl. G06F 19/00

(52) U.S. Cl. 705/7

(57) ABSTRACT

Systems and methods for generating segments of real property transactions by clustering base geographic units are provided. According to one embodiment, information regarding real property transactions is received, each transactions corresponds to a base geographic unit based on a physical location of a real property associated with the transaction at issue. For each value of a clustering function represented within the real property transactions, relatively homogeneous segments of transactions are built by aggregating transactions of the base geographic units into clusters based on a predetermined similarity function evaluating corresponding numerically valued attributes associated with the base geographic units until each segment has a sufficient number of transactions to provide desired accuracy, reliability or usefulness in the context of desired numerical modeling or analysis and all real property transactions have been assigned to a segment. Then, the desired numerical modeling or analysis can be performed based on the resulting segments.

### CROSS-REFERENCE TO RELATED APPLICATIONS

This application claims the benefit of priority to U.S. Provisional Patent Application No. 60/917,948, filed on May 15, 2007, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright (D 2007-2008, IntelliReal, LLC.

### BACKGROUND

1. Field

Embodiments of the present invention generally relate to methods of facilitating numerical modeling and/or analysis of real property transactions. More specifically, embodiments of the present invention provide methods of creating segmented transaction data built by clustering base geographical units based on similarity of statistical data associated therewith. Desired numerical modeling and/or analysis, including, but not limited to, estimating real property valuations, generating price indices, calculating trend lines and fraud detection may then be performed on the segmented real property transaction data.

2. Description of the Related Art

There are virtually no identical real properties. Even those that are of identical design and construction are situated on different parcels of land and have at least slightly different attributes that could be thought to affect the value, and over time maintenance and modifications accumulate such that the values diverge.

Meanwhile, in their current state of development, automated modeling methods necessary to generate equations that predict transfer prices are currently unable to produce the most precise and accurate results when very large numbers of categorically and numerically measured attributes are presented for pattern recognition.

### SUMMARY

Systems and methods are described for generating segments of real property transactions by clustering base geographic units to facilitate application of desired numerical modeling and/or analysis to real property transaction data. According to one embodiment, a method of performing desired numerical modeling or analysis in relation to real property transactions is provided. Information regarding real property transactions is received. Each of the real property transactions correspond to a base geographic unit of multiple base geographic units based on information regarding a physical location of a real property associated with the real property transaction at issue. For each value of a clustering function represented within the real property transactions, multiple relatively homogeneous segments of transactions are built by aggregating transactions of the base geographic units into clusters based on application of a predetermined similarity function among corresponding attributes of numerically valued attributes associated with the base geographic units until each segment has a sufficient number of transactions to provide desired accuracy, reliability or usefulness in the context of desired numerical modeling or analysis and all real property transactions have been assigned to a segment. Then, the desired numerical modeling or analysis can be performed based on one or more of the relatively homogeneous segments.

In the aforementioned embodiment, the desired numerical modeling or analysis may involve estimating an appropriate transfer price of a real property by applying one or more automated real property valuation models to a segment of the relatively homogeneous segments with which the real property is associated.

In various instances of the aforementioned embodiments, the desired numerical modeling or analysis may involve generating one or more price indices for one or more subsets of the real property transactions.

In the context of various of the aforementioned embodiments, the desired numerical modeling or analysis may involve determining one or more trend lines for the one or more subsets of the real property transactions.

In various instances of the aforementioned embodiments, the desired numerical modeling or analysis may involve performing fraud detection.

Other embodiments of the present invention provide a method of estimating an appropriate transfer price of a real property. Information regarding real property transactions is received. Each real property transaction is assigned to appropriate base geographic units based on information regarding a physical location of a real property associated with the real property transaction and statistical information either derived from the information or gathered from other sources about the base geographic units or defined agglomeration of the base geographic units. Multiple relatively homogeneous segments of real property transactions are built by aggregating one or more of the base geographic units into clusters based on application of a predetermined similarity function among corresponding numerically valued attributes associated with the base geographic units on a property type-by-property type basis until each of the relatively homogeneous segments is of sufficient size to facilitate one or more of accuracy and precision of one or more automated real property valuation models. Finally, an appropriate transfer price of a real property of interest is estimated by applying the one or more automated real property valuation models to a segment of the relatively homogeneous segments with which the real property of interest is associated.

In the aforementioned embodiment, those of the base geographic units having a number of real property transactions meeting or exceeding the sufficient size may be assigned to individual clusters.

In the aforementioned embodiment, a list of all possible pairs of base geographic units may be created and sorted by the predetermined similarity function. Then, pairs of the base geographic units from the sorted list may be assigned to the clusters.

In various instances of the aforementioned embodiments, the information regarding the physical location of the real property associated with the real property transaction may include multiple attributes of the physical location.

In the context of various of the aforementioned embodiments, the base geographic units may be one of Unites States Postal Service ZIP Codes, ZIP+2 codes, ZIP+4 codes, regions, states, counties, school districts or synthetically generated grids.

In various instances of the aforementioned embodiments, the base geographic units may be created for statistical purposes and statistics are consistently collected regarding the plurality of base geographic units.

In various instances of the aforementioned embodiments, the base geographic units may be Census Tracts.

In the aforementioned embodiment, at least one cluster of the clusters may include geographically discontinuous Census Tracts.

In the context of various of the aforementioned embodiments, clusters may be created in which no cluster includes Census Tracts from more than one county.

In the context of various of the aforementioned embodiments, the predetermined similarity function may be Euclidean distance.

In the context of various of the aforementioned embodiments, the predetermined similarity function may be Mahalanobis distance.

Some embodiments provide other real property valuation methodologies. Information is received regarding real property transactions. Each real property transaction is assigned to an appropriate base geographic unit based on information regarding a physical location of a real property associated with the real property transaction. For each property type represented in the real property transactions, relatively homogeneous segments of sufficient size are created to facilitate one or more of accuracy and precision of one or more automated real property valuation models by aggregating one or more of the base geographic units into clusters by applying a predetermined similarity function among corresponding numerically valued attributes of the base geographic units. Then, an appropriate transfer price of a real property of interest can be estimated by applying the one or more automated real property valuation models to a segment of the relatively homogeneous segments with which the real property is associated.

In the aforementioned embodiment, those of the base geographic units having a number of real property transactions meeting or exceeding the sufficient size may be assigned to individual clusters.

In various instances of the aforementioned embodiments, a list of all possible pairs of base geographic units sorted by the predetermined similarity function may be created. Then, pairs of the base geographic units from the sorted list may be assigned to clusters.

In the context of various of the aforementioned embodiments, the information regarding the physical location of the real property associated with the real property transaction may include multiple attributes of the physical location.

In some instances of the aforementioned embodiments, the base geographic units may be one of Unites States Postal Service ZIP Codes, ZIP+2 codes, ZIP+4 codes, regions, states, counties, school districts or synthetically generated grids.

In various instances of the aforementioned embodiments, the base geographic units may be created for statistical purposes and statistics may be consistently collected regarding the plurality of base geographic units.

In some instances of the aforementioned embodiments, the base geographic units may be Census Tracts.

In the aforementioned embodiment, at least one cluster of the clusters may include geographically discontinuous Census Tracts.

In the context of various of the aforementioned embodiments, clusters may be created in which no cluster includes Census Tracts from more than one county.

In the context of various of the aforementioned embodiments, the predetermined similarity function may be Euclidean distance.

In the context of various of the aforementioned embodiments, the predetermined similarity function may be Mahalanobis distance.

Some embodiments provide yet other real property valuation methodologies. Information is received regarding real property transactions. A set of segmented real property transaction data is formed by grouping the real property transactions into segments based on a function of one or more attributes associated with the real property transactions. Each real property transaction of the set of segmented real property transaction data is assigned to an appropriate base geographic unit based on information regarding a physical location of a real property associated with the real property transaction. A set of segmented and clustered real property transaction data is formed by grouping the base geographic units into clusters by applying a predetermined similarity function among corresponding numerically valued attributes of the base geographic units on a segment-by-segment basis and requiring each of the segments of clusters to have at least a predetermined minimum number of clustered elements which is defined to facilitate one or more of accuracy and precision of one or more automated real property valuation models. Then, an appropriate transfer price of a real property associated with one of the clusters may be estimated by applying the one or more automated real property valuation models to the set of segmented and clustered real property transaction data.

In the aforementioned embodiment, the information regarding the physical location of the real property associated with the real property transaction may include multiple attributes of the physical location.

In various instances of the aforementioned embodiments, the base geographic units may include one of Unites States Postal Service ZIP Codes, ZIP+2 codes, ZIP+4 codes, regions, states, counties, school districts or synthetically generated grids.

In the context of various of the aforementioned embodiments, the base geographic units may be created for statistical purposes and the statistics may be consistently collected regarding the base geographic units.

In some instances of the aforementioned embodiments, the base geographic units may be Census Tracts.

In the aforementioned embodiment, at least one cluster may include geographically discontinuous Census Tracts.

In various instances of the aforementioned embodiments, none of the clusters may include Census Tracts from more than one county.

In the context of various of the aforementioned embodiments, preprocessing the information regarding real property transactions may involve establishing the predetermined minimum number of clustered elements by making models on successively smaller sets of training data to determine a size at which the accuracy or the precision of the one or more automated real property valuation models begins to degrade; identifying suitable transactions by scrubbing the set of example transactions to exclude non-free market transactions; assigning each of the suitable transactions to a correct Census Tract; storing statistical data regarding each Census Tract by collecting, weighting and scaling data regarding the suitable transactions; and for every county and every possible pair of Census Tracts within the county, calculating and recording the predetermined similarity function based on the statistical data.

In the context of various of the aforementioned embodiments, the predetermined similarity function may be Euclidean distance.

In the context of various of the aforementioned embodiments, the predetermined similarity function may be Mahalanobis distance.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a conceptual illustration of a high-level network architecture in which embodiments of the present invention may be employed.

FIG. 2 is a block diagram conceptually illustrating interactions of various functional units of a valuation server in accordance with embodiments of the present invention.

FIG. 3 is an example of a computer system with which embodiments of the present invention may be utilized.

FIGS. 4A-4D together represent a high-level flow diagram illustrating clustering processing in accordance with an embodiment of the present invention.

FIG. 5A is a table of sample BGU data to illustrate a simplified clustering example.

FIG. 5B is a list of BGUs sorted in descending order by transaction count.

FIG. 5C and FIG. 5D together represent a partial list of BGU pairs sorted in ascending order by a similarity function.

FIG. 5E graphically illustrates the results of the clustering process as applied to the sample BGU data of FIG. 5A in accordance with an embodiment of the present invention.

FIG. 6 is a user interface screen shot of a page that may assist with property identification in accordance with an embodiment of the present invention.

FIG. 7 is an Intelligent Property Report for a subject property in accordance with an embodiment of the present invention.

### DETAILED DESCRIPTION

Systems and methods are described for generating segments of real property transactions by clustering base geographic units to facilitate application of desired numerical modeling and/or analysis to real property transaction data. For example, in accordance with an embodiment of the present invention, clustering of Census Tract data may be performed based on similarity statistical data gathered by the Census Bureau, for example, to create segments of real property transactions of sufficient size to facilitate the subsequent application and accuracy of predictive real property valuation models.

According to various embodiments of the present invention, a plethora of raw data, including Census Tract data, are received as inputs to an Intelligent Automated Valuation Model (iAVM™), which accurately predicts the future transfer price of any individual residential real estate parcel and its associated improvements (“real property”) situated in any location over a wide geographic area (iAVM is a trademark or registered trademark of IntelliReal LLC of Lakewood, Colorado, USA).

In one embodiment, groupings of base geographic units (BGUs) (e.g., Census Tracts) (referred to herein as “clusters”) and groupings of real property transactions (referred to herein as “segments”) are identified and based thereon one or more separate property valuation methodologies, such as Corrected Trend Model (CTM), KARL, Corrected Assessor Model (CAM) and the Expert System (ES), are performed.

ES is a computational embodiment of professional appraiser best practice using “Comparable Sales Methodologies” that infer the value of a subject property by referring to transaction values for nearly identical properties; when property attributes are not identical the property is treated as a collection of valued attributes (differentiated good) that together sum to the total value of the property thus allowing for valuation corrections based upon attribute differences. ES is presently embodied as an automatic or Appraiser Assisted system.

KARL is a computational embodiment of linear and/or non-linear piecewise regression on transaction values of segmented properties and their associated attribute data that determines the hedonic value of the individual attributes; weightings determined by KARL provide input to ES that improves valuation adjustments based upon attribute differences.

CTM is a computational methodology that generates price indices for each segment, establishes each transaction's value relative to the generated trend line and allows the correction of a transaction value to past or future time (time shifting).

CAM is a computational methodology that automatically extracts the assessment ratio from a segment of data thus allowing valuations to be extracted from county assessor valuations. The valuations produced by any of these methodologies and other existing and future property valuation methodologies are improved by better segmentation of supplied data.

The clustering methodologies described herein may facilitate the provision of more homogeneous, segmented data for any modeling task that depends upon a minimum sized segment for accuracy, reliability, precision and/or usefulness. In embodiments in which estimated values are desired for real estate transactions, base geographical units may be clustered to create segments, which can be used to produce independent valuations with associated quantifiable confidence scores. Then, the most accurate value may be reported or used for subsequent processing. According to one embodiment, the most accurate value is selected from the one or more separate property valuation methodologies. In other embodiments, a weighted valuation of one or more of the separate property valuation methodologies may be used.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, MultiMedia Cards (MMCs), secure digital (SD) cards, such as miniSD and microSD cards, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, various embodiments of the present invention may be described in the context of real property valuation and clustering of transactions to create sufficiently sized segments using Census Tracts as the base geographic unit, the present invention is equally applicable to various other datasets and objects. The methodologies described herein may also be used to cluster objects that have no sub-elements into clusters of at least x elements by counting the number of elements assigned instead of summing the number of sub-elements as described herein. In short, the method of clustering described herein is thought to have applicability in any field or problem domain in which it is desirable to construct clusters of objects with numerically valued attributes.

### Terminology

Brief definitions of terms, abbreviations, and phrases used throughout this application are given below.

The phrases “base geographic unit,” “base geographical unit,” “base geographic element” and “base geographical element” generally refers to a definable geographical areas. Examples of base geographic units include, but are not limited to census blocks, census block groups, census tracts, counties, states, school districts, Metropolitan Statistical Areas (MSAs), ZIP Codes, ZIP+2, ZIP+4 codes, or synthetically generated grids, which may or may not overlap, and the like.

The term “cluster” generally refers to a grouping of objects of a dataset having numerically valued and/or statistically valued attributes and a predetermined similarity among the attributes as measured by a particular similarity function, such as Euclidean distance among corresponding attributes. According to one embodiment, real properties are associated with clusters and each cluster represents a collection of base geographic entities that are grouped together based upon similarity of attributes of the base geographic entities. In one embodiment, attributes associated with the base geographic entities are numerical attributes representing similarity statistical data, such as that collected by the Census Bureau. In one embodiment, base geographic units having known homogeneous social, economic, and demographic attributes are clustered to produce segments holding a sufficient number of real property transactions of the same property type. In one embodiment, the base geographic units may be ZIP Codes, Metropolitan Statistical Areas (MSAs) or a geographic base unit providing more granularity than MSAs, such as Census Tracts or the like. Depending upon the particular implementation, clusters may be continuous or discontinuous. In some embodiments, each base geographic entity within a cluster may be required to be adjacent to another. In other embodiment, adjacency to another base geographic entity within the cluster is not a prerequisite to association with a cluster.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with another. Based on the disclosure provided herein, one of ordinary skill in the art will appreciate a variety of ways in which connection or coupling exists in accordance with the aforementioned definition.

The phrase “Corrected Assessor Model” or the acronym “CAM” generally refer to a method of extracting and tuning the county or state assessment ratio, the function relating the assessor's full market value assessment to the assessed value. In one embodiment, CAM is a computational methodology that automatically extracts the assessment ratio from a segment of data thus allowing valuations to be extracted from county assessor valuations.

The phrase “Corrected Trend Model” or the acronym “CTM” generally refer to a method of generating indices for each segment and time shifting transaction values relative to the generated indices. In one embodiment, CTM is a computational methodology that generates price indices for each segment, establishes each transaction's value relative to the generated trend line and allows the correction of a transaction value to past or future time (time shifting).

The phrase “Expert System” or the acronym “ES” generally refer to a comparable sales methodology that uses appraiser best practices to generate valuations either unsupervised or with appraiser supervision. In one embodiment, ES is a computational embodiment of professional appraiser best practice using “Comparable Sales Methodologies” that infer the value of a subject property by referring to transaction values for nearby identical properties; when property attributes are not identical the property is treated as a collection of valued attributes (differentiated good) that together sum to the total value of the property thus allowing for valuation corrections based upon attribute differences.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The acronym “KARL” generally refers to a computational embodiment of linear and/or non-linear piecewise regression on transaction values of segmented properties and their associated attribute data that determines the hedonic value of the individual attributes; weightings determined by KARL provide input to ES that improves valuation adjustments based upon attribute differences.

If the specification states a component or feature “may”, “can”, “could”, or “might” be included or have a characteristic, that particular component or feature is not required to be included or have the characteristic.

The term “responsive” includes completely or partially responsive.

The term “segment” generally refers to another form of grouping of objects of a dataset. According to one embodiment of the present invention, a segment represents a collection of transactions for a particular value of a clustering function (e.g., property type, transaction type or combination of attributes) relating to real properties residing within one or more homogeneous clusters. In one embodiment, real property transaction information includes numerically and/or categorically valued attributes. In one embodiment, segments having sufficient number of transactions are built by clustering groups of one or more base geographic units together and assigning the transactions within such clusters to appropriate segments. In one embodiment, agglomerations of base geographical units are created based on attribute similarity to construct appropriately sized segments of real property transactions for one or more values of a clustering function (e.g., a function based on attributes associated with the real property transactions, such as property type, property style, price tier and the like, individually or in combination). The segmented transactions may then be used to develop models that can be applied for the purpose of valuing properties, creating indices, generating trend lines and the like. In one embodiment, a segment represents a grouping of real property transactions based on one or more attributes associated with the transaction and/or the real property at issue. According to one embodiment, real property valuation estimation involves analysis of appropriately segmented real property transaction data built by clustering homogeneous sets of Census Tracts.

### Overview and Technical Background

In their current state of development, automated modeling methods necessary to generate equations that predict transfer prices are currently unable to produce the most precise and accurate results when very large numbers of categorically and numerically measured attributes are presented for pattern recognition. The performance of modeling engines is much enhanced by the identification of homogeneous segments relative to as many attributes as possible, because this allows a reduction in the number of variables that must be simultaneously processed. This is universal in the field of model discovery not limited to the sub-field of creating models for predicting real property transfer values.

One problem, or objective, therefore is to devise a method of grouping many millions of real properties into segments in such a way that many attributes affecting price can be held constant within each segment while those same attributes vary from segment to segment. This minimizes the difficulty of identifying the influence that each remaining variable attribute has within each segment facilitating the creation of an accurate and precise predictive model.

There are virtually no identical real properties. Even those that are of identical design and construction are situated on different parcels of land and have at least slightly different attributes that could be thought to affect the value, and over time maintenance and modifications accumulate such that the values diverge.

There are, however, recognized classes of properties, property types that systematically command differing hedonic component values. For example the value of one square foot of heated floor area is demonstrably different, all else held constant, for a detached single family dwelling than for attached single family dwelling or a condominium.

The probable transfer price of a real property varies from place to place in the sense that raw land commands a different price per unit of area in one locale than in another and that an identical improvement transported from land in one locale to another will also command a different price. The distance between one locale and another can be quite small relative to the change in price and the locales and the price gradient is discontinuous. Therefore variation in transfer price given identical real property is based in large part upon the attributes of the locale in which the real property is situated.

The attributes of locales that affect the values of the real properties situated within them can be either be statistically characterized or are common throughout entire areas. Examples of these attributes might be school district, tax rates, proximity to shopping, transportation, jobs, the economic environment, median house price, etc.

For the prediction of real property values, which are locale dependent as mentioned earlier, the most efficient segmenting method would be based upon both property type and locales composed of geographic base units with well defined size and location relative to important physical and political divisions, and having known homogeneous social, economic, and demographic attributes.

It is theoretically better to have the locales as small as possible, but pattern recognition (modeling) considerations demand that a sufficient number of examples be available to fully disclose how changing attributes affect pricing patterns. This means that after a base geographic unit meeting the conditions above is selected a method of clustering the most similar units to produce geographic segments holding a sufficient number of transactions of the same property type should be devised.

Real property records compiled by county assessors and recorders are the primary available data source of data available for creating these predictive models. Since these records can be viewed as a number of separate data sets equal to the number of counties or other data collecting entities, segments may be constructed so that they are not cut by county or other entity boundaries. For some implementations, this implies a preference for geographic base units that are not cut by county lines, and since real property to be modeled covers the entire geography so should the collection of all base geographic units cover the complete geography to be modeled.

Since collections of similar base geographic units are required, the statistical attributes used to compare the base geographic units should be universally available as well as consistently collected and computed.

In short, an existing problem in the field of automated property valuation methodologies is to identify the best geographic base unit and devise a method a clustering these base units based upon a definition of similarity and to select the smallest possible geographic area while identifying clusters of geographic base units containing a sufficient number of example transactions to satisfy the requirements of modeling.

While existing methods of grouping real property transactions use USPS ZIP Code as the base geographic unit, ZIP Codes are in some cases inadequate as base geographic units because they are not created for statistical purposes. ZIP Codes are not delineated to be statistically homogeneous, statistics are not consistently collected about them, they cross county lines, and they change continuously. On the other hand, Census Tracts are created and delineated primarily for statistical purposes, are demographically, economically, and socially homogeneous and of nearly equal population, extensive statistics are consistently collected and published for the express purpose of comparing one to another, and they change not more often than once per decade.

Existing clustering methodologies do not focus on defining clusters of a specific minimum number of clustered elements. Rather, existing methodologies seek to identify clusters only of maximum similarity thereby leaving the number of clustered elements uncontrolled. In short, no existing methodology appears to satisfy the requirements of the problem at hand.

As will be described further below, the clustering methodology according to various embodiments of the present invention allows the definition of clusters composed of similar units in the geographic domain with similarity defined in a very high dimensional vector space and containing a minimum number of units in the transactional domain. While the number of units in each geographic base unit could be considered an attribute of the base unit, according to various embodiments of the present invention, the method gives that attribute the special significance required by the end goal of creating robust mathematical models based on the output of the process realizing the method.

The clustering methodologies described herein are particularly suited to the implementation of automated model creation where a number of similar elements are clustered to attain a certain minimum cluster size based upon a total number of sub-elements in each cluster, but can also be adapted to cluster at simply the element level. The methods are particularly suitable because of their simplicity for use with very large data sets from which require the production of a very large number of segments and subsequent predictive models on those segments.

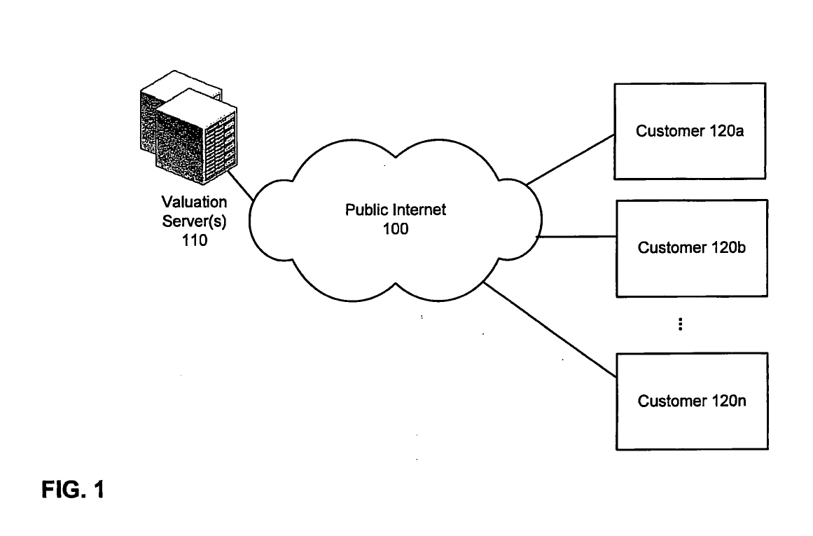

FIG. 1 is a conceptual illustration of a high-level network architecture in which embodiments of the present invention may be employed. In the present example, one or more valuation servers 110, which may be part of an application service provider (ASP) or web-based service, are coupled in communication with multiple customers 120a-n via a network, such as the public Internet 100.

According to one embodiment of the present invention, valuation server(s) 110 are part of a subscription service, which performs numerical modeling, analysis and reporting in relation to real property valuations. Depending upon the particular implementation, customers 120a-n may access analysis and reports for real properties of interest via a web-based interface, via batch submission and/or data feeds. In alternative embodiment, all or some subset of the software and algorithms running on valuation servers 110 may be delivered to clients in the form of an application program for use on their desktop computers.

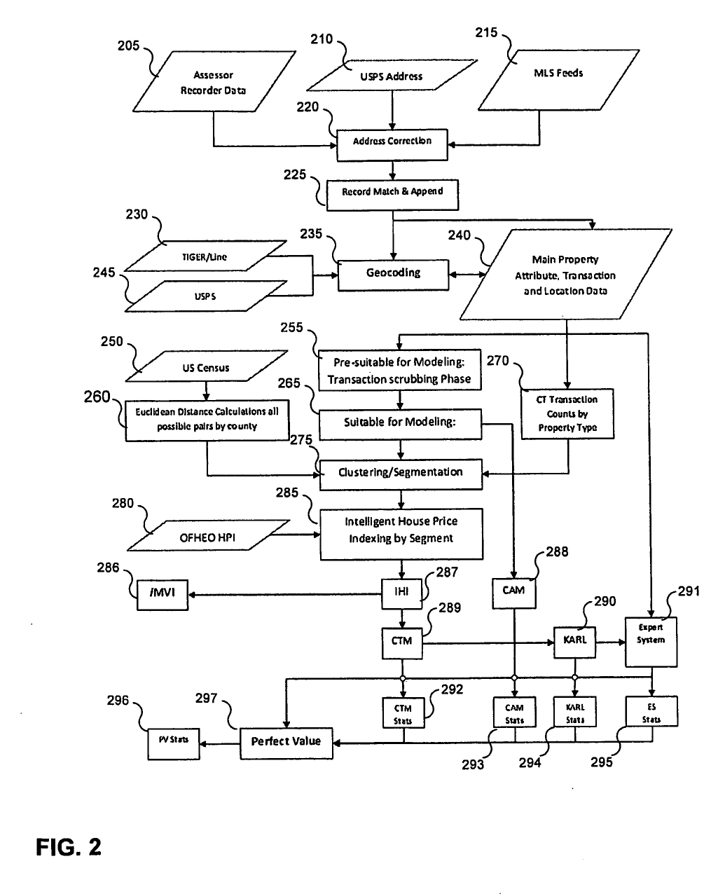

FIG. 2 is a block diagram conceptually illustrating interactions of various functional units of the valuation server(s) of FIG. 1 with external data sources in accordance with embodiments of the present invention. According to the present example, in this figure, multiple data sources, including, but not limited to, exemplary Assessor Recorder Data 205, USPS Address Data 210, MLS Data feeds 215, TIGER/Line 230, USPS TIGER/Zip+4, US Census 250 and OFHEO 280 are acquired directly from originators or from commercial or partner data aggregator providers. According to one embodiment, these data feeds are aggregated into Main Property Attribute, Transaction and Location Data warehouse 240 through a series of steps into a single database schema including the normalizing of data from all providers into that schema.

In one embodiment, the process proceeds as follows for each data feed: For example, Assessor Recorder Data 205 as periodic data feeds, which together represent the majority of all real property transaction and attribute data for the tracked geographical area, in this example only limited to the United States of America, is received in batch or transaction-by-transaction feeds. Typically, each real property is identified by a postal street address, Assessor Parcel Number and/or other unique or quasi-unique identifier, and each transaction is paired with a unique property. To facilitate identifying a property identified by postal street address all property addresses may be modified to conform to USPS addressing standards. The standardized addresses are compared to the USPS database 210 of deliverable addresses and any mismatches are noted in an Address Correction procedure 220. The original input addresses are recorded together with the standardized addresses and are appended to the incoming record and saved in an historical archive. These addresses together with other identifiers are the used to either identify a property that is already stored in Main Property Attribute, Transaction, and Location Data archive 240, using a Record Match & Append procedure 225. The Address Correction procedure 220 also provides a reliable ZIP+4, 9 digit ZIP Code, for use in subsequent processes. A similar procedure is followed for all other attribute and transaction feeds from a plurality of sources such as MLS feeds and World Wide Web.

In the case that the incoming transaction, attribute or combination record from any of the aforementioned batch or streaming sources is located in the database the incoming record is scanned for changes, an updated attribute record including merged attributes replaces the existing record, the previous record is stored in the historical file for the subject property, and if the record contains transactional information such as a transfer of ownership, the transactional information is added to separate serial transaction file for the subject property. Each transaction added to the serial transaction file for each subject property is classified as a duplicate of another transaction, free market transaction, provisional free market transaction, company transaction, foreclosure transaction, non-arms length transaction, distressed transaction and so forth based upon statistical and logical tests at the time of insertion into the serial record. The utility of some exemplary classifications are described below in this document. Classification of individual transactions are revised periodically based upon continuously recalculated statistics of the segment to which the property belongs, as described below, and the classifications are adjusted from time to time as needed for the production of the products and reports that are produced from the data warehouse. In various embodiments of the present invention, each transaction can be a member of multiple classifications. Any property matched to an existing record set in the Main Property Attribute, Transaction and Location Data procedure 240 is recorded as described above. New properties, those not matched by Record Match & Append 225 or periodically all properties are submitted or resubmitted to a Geocoding procedure 235. The Geocoding procedure 235 uses the standardized address to identify an appropriate set of records in the TIGER/Line database 230 updated periodically by the Census. These records are identified within the database by their TIGER/Line ID (TLID) (not shown).

To facilitate locating the appropriate TLID for a particular record the USPS data 245, comprised in this embodiment of TIGER/ZIP+4 database (which is frequently employed by the Geocoding procedure 235 to reduce processing time, as this database is cooperatively created by TIGER and USPS) cross references of TLIDs and ZIP+4 Codes, 9 digit ZIP Codes may be used. Other methods to speed processing of the identification of the correct TLID also include the use of commercially available address standardization/correction geocoding packages that return the TLID as part of address standardization. Once the correct TLID is identified, the Geocoding process 235 allows the extraction and appending of location attributes including, but not limited to, the interpolated longitude and latitude, school district, county, Census tract, Census block, Census block group, side of the street, proximity and relative to each subject property the direction to water, railroads, public transportation, shopping, commercial areas, major highways, major streets, and other relevant attributes directly as retrieved from TIGER/Line 230 or through computation known to those skilled in the art. The aggregation of Digital Elevation Model data (not shown), with the latitude and longitude allows each property elevation to be recorded as well, allowing accurate indications of topography and visual attributes, such as scenic views, to be appended as value influencing attributes.

The Geocoding process 235 may be proprietary code implemented explicitly for the aforementioned purposes or commercial software and data may be used to fulfill this functionality. The attributes thus appended are utilized as indicators of property value or directly in a Clustering/Segmentation process 275 as will be described elsewhere in this document.

According to one embodiment, a Pre-suitable for Modeling: Transaction Scrubbing Phase process 255 is the first step of classification of transactions into free market, etc., categories described above. In various embodiments of the present invention, this process takes place at the county level of granularity. In such cases, this means that only property transactions from a single assessor/recorder data originator are considered together for statistical purposes. The Pre-suitable for modeling process 255 classifies certain transactions. First, land subdivision transactions may be identified based upon a threshold number of geographically grouped parcels, having identical transaction dates and identical or nearly identical prices that are inordinately high relative to the properties' probable value. After these transactions are identified and classified in the data, all assessor/recorded coded transactions indicative of non-free market status may be classified accordingly. The various transaction classes identified may then be used to create other data products, which will be described later in this document.

The free-market class of transaction is used to create the retail products including, but not limited to, retail price trends and to serve as training sets for the retail Automated Valuation Model (“AVM”), while wholesale, distressed, company owned and other transaction classes are used to generate price trends and as training sets for the wholesale, distressed, company owned and other transaction classes, AVMs and other wholesale, distressed, company owned products. In one embodiment, each class of transaction receives independent but similar treatment. For simplicity and in an effort to avoid needless repetition, only the process to generate retail trends, AVM products and other products will be described. The existence and implementation of parallel processes for other classes of transactions will be understood by those skilled in the art.

According to one embodiment, the only AVM model to produce valuations without prior clustering/segmentation is the Corrected Assessor Model (“CAM”) 288. CAM 288 receives retail classified transactions for each land use type (also herein called “property type”) and compares the actual recorded transaction values within a given time period, in this embodiment the one year or 18 months used by the assessor to calculate her own property values, with the assessor calculated market value, assessed value, appraised value, etc., depending upon what value(s) the assessor of each jurisdiction collects and reports in the data for her jurisdiction. This produces a bulk median ratio of each assessor value to the real transactions, and a distribution of errors that is iteratively adjusted to minimize the total error and the standard deviation of percent errors for each property type for each of the several values returned by the assessor and for each quartile of assessed values, full market values, etc. returned by each assessor. The ratio and calculated adjustments can then be used to estimate the retail value of each property for which the assessor returns any one or several values of the aforementioned assess or generated values to generate the CAM valuation. The rest of the transactions in, for example, the retail (also called herein the free market) classification are then subjected to the Clustering/Segmentation process 275.

Segmentation (the Clustering/Segmentation process 275) in this sense is defined as the grouping together of homogeneous, relative to in some embodiments property type and/or price quartile, base geographical units (e.g., Census Tracts/ZIP Codes—both of which may be used in some embodiments), by number of classified transactions, in this example retail transactions, in order to assure that a sufficient number of classified transactions is available to train the individual models (e.g., one or more of a Corrected Trend Model (CTM) 289, KARL 290, a hedonic multiple regression model, and Expert System (ES) 291, in some embodiments either an appraiser emulation or appraiser assisting model, to produce trend lines and indices, to identify fraudulent transactions, and to produce AVM Valuations for past, present or forecastable future time, to predict, given loan attributes, Loan to Value ratios, predict current equity, to monitor loan performance, identify flipping, value market risk, value portfolios of loans and properties, and a plurality of other products as demanded from time to time by the market.

The quality, accuracy and precision of all of these products are dependent upon selecting groups of properties (segments) that are homogeneous relative to reaction of their values to the net of the market forces at work in a given segment. Clustering agglomerates similar areas populated with properties with specific attributes that have transactions that can be segmented to train models and produce the aforementioned products. The details of clustering and segmentation are described in detail below.

Once segments of transactions of properties are defined, the transactions are submitted to an Intelligent House Price Indexing by Segment process 285 where another round of statistical outlier identification is performed in each segment for each year and quarter. This process identifies outliers in skewed distributions. After this cleansing process, the remaining transactions for each segment are trended and the trends are indexed. This process uses the actual remaining segment transactions for each year and quarter. As described further below, in one embodiment, the Clustering/Segmentation process 275 assures that each segment has a sufficient count of transactions to create a robust trend line. The median transaction price in each homogeneous segment is calculated and is recorded as the median price trend point for its respective segment. In various embodiments, there are approximately 15,000 individual retail Census tract-property type based segments in actual production, which cover more than 800 counties and approximately 85% of all residential properties in the USA. Occasionally, there are insufficient transactions in an isolated year and quarter to create a robust median; in this case the missing points may be interpolated between two actual quarterly points. In even rarer cases, a number of successive quarters cannot be calculated; in this second case, the percent change in House Price Index (“HPI”) for the relevant CBSA as published quarterly by the Office of Federal Housing Enterprise Oversight (“OFHEO”) may be used to approximate the missing trend points. In one embodiment, standard statistical comparisons between the resulting trend lines are used as a quality assurance method e.g. R-Square, total absolute difference, etc. According to various embodiments, trend lines are also similarly produced for each aforementioned class of transaction or difference between trend lines, selected ratios as well as for each class of transactions at the ZIP Code, ZIP Code Tabulation Area, County, Core Based Statistical Area, Census Division, Census Region and the Nation levels. Both weighted average rollups of more granular segments to these levels or stand-alone trends may be directly produced at the various geographical granularities. These trend line products can be delivered as median price trends or for convenience of comparison indexed to a value of 100 at any convenient base date using standard indexing arithmetic well known to those proficient in the art.

One type of index produced in two temporal granularities, annual and quarterly, the Intelligent Housing Index (“IHI”) 287, is used as the base index for the Intelligent Market Volatility Index (“iMVI”) 286, an annual and quarterly segment level and weighted average rollup to County, CBSA, State and National levels. At the “IHI” segment level the IHI 287 is identical with the iMVI product 286.

The IHI 287 is also used internally to “time correct” transaction prices. The “time corrected” transaction prices are the output of a Corrected Trend Model (“CTM”) 289, which delivers valuations on previously sold properties and is one of the four basic valuation methodologies supplying property valuation to Perfect Value 297. CTM 289 operates on the assumption that the transaction values of homogeneous sets (segments) of properties produced by the Clustering/Segmentation process 275 as they respond to the local market forces follow the “IHI” trend line. This means that if a property was valued at e.g. $100,000 one year ago and the percent change in the “IHI” for the segment was e.g. 10% then today's most probable transaction value for that property today would be $110,000. Since it is impractical to value more that 80 million properties daily, IHI 287 may used to time shift stored AVM valuations between valuation dates as the system continuously cycles through segments and refreshes valuations of all properties in every segment as the system cycles through them. Periodic valuations may be captured over time for all properties creating a historical record of property values. In one embodiment, these values are trended and the resulting trends indexed creating a plurality of trend lines/indices, one for each property. These trend lines/indices may be used to create periodic statistical report products on demand that allows a complete view of the state of the housing market as any point in time and at any desired granularity.

Another use of IHI 287 by way of CTM 289 as described in the preceding paragraph is to create robust training sets for KARL 290. According to one embodiment, KARL 290 is an AVM which produces valuation estimates and attribute weights. Because of the extreme granularity of the segments produced by the Clustering/Segmentation process 275, the number of Suitable for Modeling 265 transactions in the very recent past relative to the desired value date may be suboptimal for training a robust regression model. In this case, CTM 289 is used to time correct the most recent transaction values to the desired value date either forward or backward in time until enough transaction values are available to provide sufficient records to produce a robust multiple regression models. The optimal number is determined by iteration of model training, model testing and adjustment of the size of the training set until the optimal balance between training set size and model accuracy is achieved. At any rate, in various embodiments of the present invention, the Clustering/Segmentation process 275 always creates segments with a sufficient number of transactions to support a robust model after time shifting even with a margin of error, which is one of its extreme strengths. Using this iterative methodology, KARL 290 is able to produce an optimally robust model in almost every case.

The Expert System (ES) 291 makes use of both the IHI 287 trend lines and their indices and the segments produced by the Clustering/Segmentation process 275, as well as some outputs of KARL 290. ES 291, in the present embodiment, can either automatically emulate the actions of an expert appraiser or can assist an expert human appraiser to produce property appraisals and supporting reports. ES 291 searches the database for comparable properties, first within an expanding distance band about the subject property using algorithms within Geocoding 235 until it reaches the geographic boundary of a selectable geographical area e.g. Census block, block group, ZIP+2, etc. If it fails to find suitable nearby comparable properties with recent transactions, it reverts to seeking comparable properties not by distance but within the cluster of possibly geographically discontinuous base geographic units comprising the segment for the property type and price tier of the subject property to prevent seeking comps in inappropriate areas. To improve the accuracy of comparable pricing within the automatic ES application 291, the values of comparables is time shifted if necessary using the IHI 287 index for the segment. In addition, KARL 290 produces attribute weightings that quantify the relative importance of property attributes within each segment which ES 291 uses to more accurately adjust comparable properties for attribute differences compared to the subject property. In the same way, KARL 290 identifies the hedonic value of each property attribute.

For each model, the training testing process produces a set of statistics: CTM Stats 292, CAM Stats 293, KARL Stats 294, and ES Stats 295. In one embodiment, these statistics include more than 120 individual measures that fully characterize the performance of the model by various measures, including, but not limited to, complete distribution of percent errors and other standard statistical measures well known to those skilled in the art together with a confidence score and a “One Score” measurement that measures the total quality of a model's accuracy and precision and allows absolute ranking by this single measure. According to one embodiment, the transactions agglomerated for each segment by the Clustering/Segmentation process 275 are apportioned into two sets by simple random sample. One of the two simple random samples contains eighty percent of the transactions identified by the Suitable for Modeling process 265, this is called the training set, and the remaining twenty percent of the transactions are called the test set or holdout sample. The training set is used to train the models and the holdout sample is used to measure the accuracy and precision of the resulting model. All of the transactions have a known or reference value. After a model is trained, it is applied to every property in the hold out sample to produce a model estimated valuation. The real transaction values are then mathematically compared to the estimated valuations to determine the percent error of each estimated valuation relative to the real transaction value. The statistics for each valuation methodology, as detailed above, are computed and stored for each methodology for each segment. Since the holdout sample for each model is comprised of exactly the same records for all models trained for each segment, the resulting statistics are a fair and comparable representation of the relative performance of each valuation method within each segment.

The final output of the AVM is produced by Perfect Value 297, which uses the statistics of each individual valuation methodology feeding it to determine either which valuation methodology's output is to be selected as the delivered AVM value or alternatively produces a blended valuation when there is no clear winner. After all the records in the segment holdout sample are valued by Perfect Value 297, PV Stats 296 are computed in the same manner as described for each of the other valuation methodologies, CTM 289, CAM 288, KARL 290 and ES 291. The accuracy and precision of Perfect Value 297 is invariably superior to any one of the primary valuation methodologies. The PV Stats 296 and the valuation output produced by Perfect Value 297 is a component of the AVM product output together with iMVI 286 indices, detailed comparables, risk scores, confidence scores etc. produced by the system.

While in the environment of the present example, the various functional units have been described as if they were all implemented within a single valuation server, in alternative embodiments one or more of these functional units may be implemented within a separate server or executed within a host system. For example one server may be dedicated to information gathering and another may be dedicated to modeling.

In one embodiment, the functionality of one or more of the above-referenced functional units may be merged in various combinations or further divided into additional functional units. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, software code and the like) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media or flash memory devices.

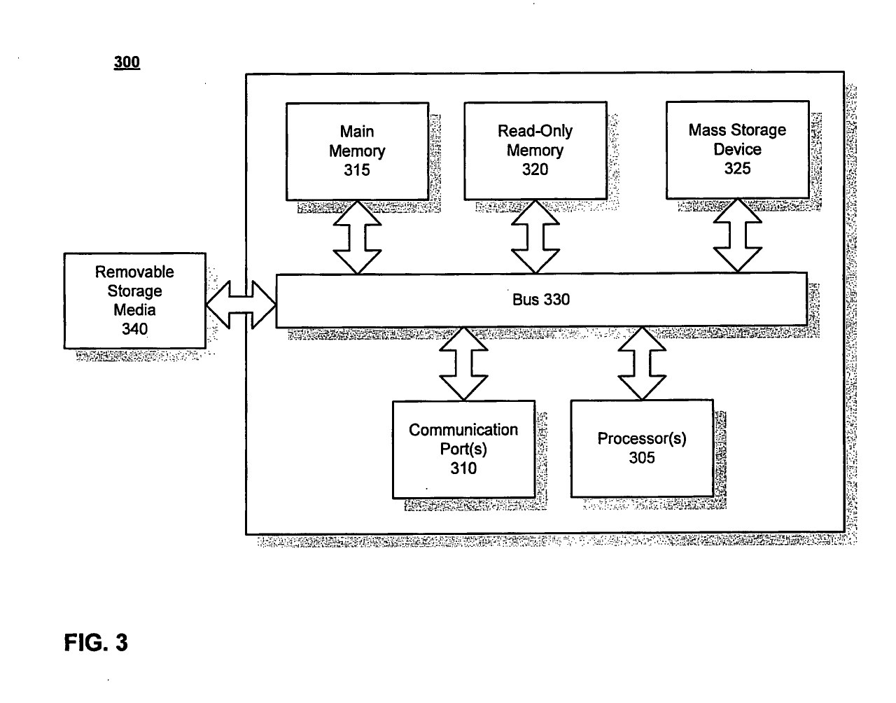

Embodiments of the present invention include various steps, which will be described in more detail below. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 3 is an example of a computer system 300, such as a client device or Web server, upon which or with which embodiments of the present invention may be utilized.

According to the present example, the computer system includes a bus 330, at least one processor 305, at least one communication port 310, a main memory 315, a removable storage media 340 a read only memory 320, and a mass storage 325.

Processor(s) 305 can be any known processor, such as, but not limited to, an Intel® Itanium® or Itanium 2 processor(s), or AMD® Opteron® or Athlon MP® processor(s), or Motorola® lines of processors.

Communication port(s) 310 represent physical and/or logical ports. For example communication port(s) may be any of an RS-232 port for use with a modem based dialup connection, a 10/100 Ethernet port, or a Gigabit port using copper or fiber. Communication port(s) 310 may be chosen depending on a network such a Local Area Network (LAN), Wide Area Network (WAN), or any network to which the computer system 300 connects.

Communication port(s) 310 may also be the name of the end of a logical connection (e.g., a Transmission Control Protocol (TCP) and/or User Datagram Protocol (UDP) port). For example communication ports may be one of the Well Know Ports, such as TCP port 80 (used for HTTP service), assigned by the Internet Assigned Numbers Authority (IANA) for specific uses.

Main memory 315 can be Random Access Memory (RAM), or any other dynamic storage device(s) commonly known in the art. Read only memory 320 can be any static storage device(s) such as Programmable Read Only Memory (PROM) chips for storing static information such as instructions for processor 305.

Mass storage 325 can be used to store information and instructions. For example, hard disks such as the Adaptec® family of SCSI drives, an optical disc, an array of disks such as RAID, such as the Adaptec® family of RAID drives, or any other mass storage devices may be used.

Bus 330 communicatively couples processor(s) 305 with the other memory, storage and communication blocks. Bus 330 can be a PCI/PCI-X or SCSI based system bus depending on the storage devices used.

Optionally, in the case of a server and typically in the case of a fixed client device, such as a desktop computer, operator and administrative interfaces 335, such as a display, keyboard, and a cursor control device, may also be coupled to bus 330 to support direct operator interaction with computer system 300. Other operator and administrative interfaces can be provided through network connections connected through communication ports 310.

Removable storage media 340 can be any kind of external hard-drives, floppy drives, IOMEGA® Zip Drives, Compact Disc-Read Only Memory (CD-ROM), MultiMedia Cards (MMCs), secure digital (SD) cards, such as miniSD and microSD cards, Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

### Clustering Processing Overview

According to various embodiments of the present invention, clustering methodologies are used to facilitate the provision of relatively homogeneous, segmented real estate transactional data which can then be used in the context of various numerical modeling and/or analysis, such as real property valuation, generation of price indices, calculation of trend lines and fraud detection. The clustering methodologies described herein are particularly useful in connection with defining clusters of at least a specific minimum number of clustered elements as may be required by particular mathematical models.

In one embodiment, a method of clustering utilizes Census Tracts as defined by the US Census Bureau as the base geographical unit (BGU). The method of defining geographic similarity between BGUs may utilize a subset of the statistics collected by the US Census Bureau Decennial Census, 396 for each Census Tract. According to one embodiment, the statistics are normalized across all Census Tracts after weighting within Census Tracts, if required. Then, Euclidean distances between all possible pairs of Census Tracts in each county are computed for all counties computing the distances from the weighted and normalized Census statistics. The method can be used with numerical attributes in any number of dimensions from any source and some sources other than US Census Bureau statistics may be used in accordance with various embodiments of the present invention.

In the context of some embodiments described herein, groupings of Census Tracts are called clusters and groupings of transactions by property type (or some other attribute(s) or clustering function) are called segments. Transactions are transfers of ownership of real property from one party to another in which one party, the buyer, gives money to another party, the seller, in consideration of the transfer of ownership of the real property from the seller to the buyer. Depending upon the property type, the real property transferred can be a demarcated area of land, called a parcel, or multiple parcels; a structure, called an improvement; a parcel or parcels together with the associated improvements; some part of an improvement with or without ownership of the parcel; or rights to use part of the improvement. The amount of money exchanged is the measure of the value of the real property if the transfer is a free market exchange.

Every property has a physical location, e.g., latitude and longitude, and every physical location resides in some hierarchical area (like a Census Block, Census Block Group, Census Tract, County, State, Nation for example). In various embodiments of the present invention, the areas, the BGUs, each have numerically valued statistical data that capture the attributes of the demographic, social, and economic environment in which the property resides at various hierarchical levels. For purposes of the simplified concrete example discussed below, only transactions on a single property type are in a single segment. For purposes of this discussion, a transaction has the location of the parcel or parcels on which the transferred property is situated and can therefore be assigned to a unique Census Tract. In cases where parcels or multiple parcels reside in more than one Census Tract, the transaction is defined as existing in the Census Tract with the larger or largest land area. In the example described below, all segments include only one property type. Every Census tract is assigned to one segment for each property type that has at least one property of that type situated within it. This means that each Census Tract may be and usually is assigned to more than one segment, but each transaction belongs to one and only one segment. In one embodiment, a cluster of Census Tracts does not include Census Tracts from more than one county. Some very large counties are divided into several geographical areas to facilitate processing.

### Preprocessing:

1. According to one embodiment, a minimum required number of sample transactions is established for a segment by making models on successively smaller sets of typical training data and noting at what set size the accuracy and/or precision of the models begins to degrade. The minimum number of transactions, segment size, is then set comfortably above that number of transactions. The method allows for the required minimum segment size to be held constant for all segments or varied segment-by-segment by the clustering function value (e.g., property type, transaction type, property style, price tier, etc.) or for statistical reasons at need.

2. Example transactions are assigned to the correct BGU, e.g., Census Tract.

3. Example transactions for every real property of meeting a clustering function, e.g., a particular type, in each county are statistically and geospatially scrubbed to exclude all except free market transactions. The remaining transactions are marked suitable for clustering.

4. The number of suitable transactions are counted and recorded for each BGU, e.g., Census Tract, by permissible clustering function value, e.g., property type.

5. The statistics for each BGU are collected, weighted, scaled and the resulting values stored.

6. For each county every possible pair of BGUs is identified and a similarity function, e.g., the Euclidean Distance, is calculated between each pair and recorded using the values stored in 5. In one embodiment, this computationally expensive activity need only be performed once for all possible pairs of BGUs; thus representing a dramatic improvement over existing agglomerative methods that require dynamic recalculation of the distance metric between the current state of the cluster and all prospective members of the cluster as the clusters are being built.

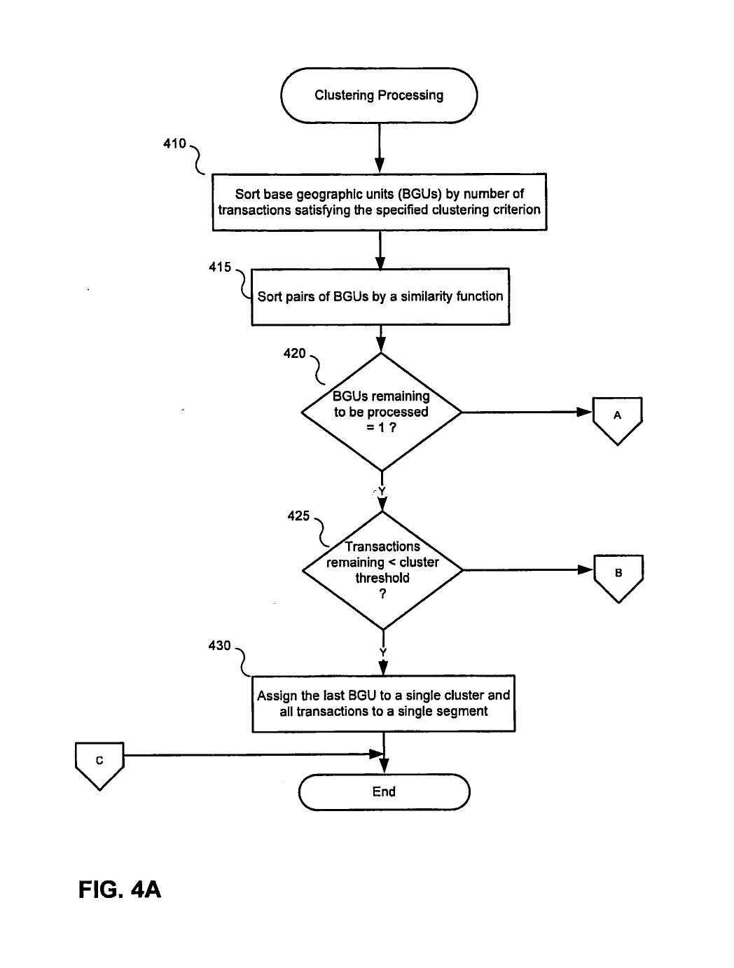

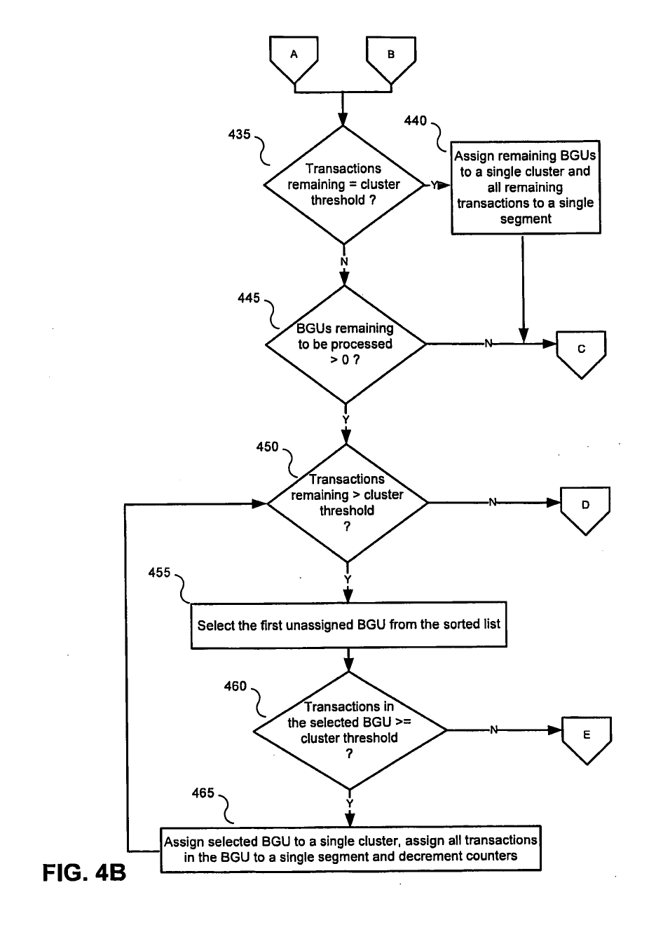

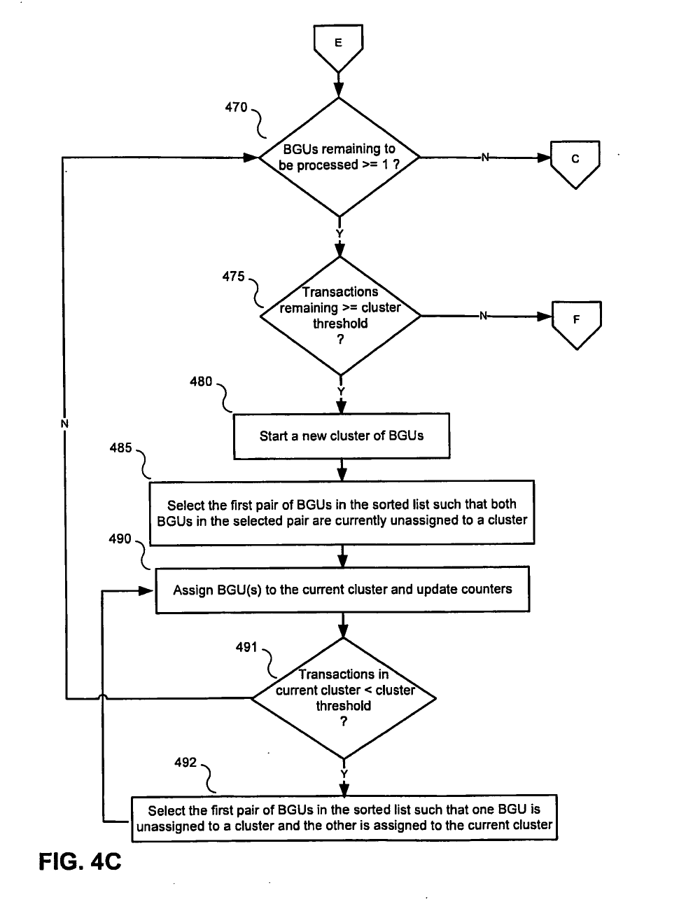

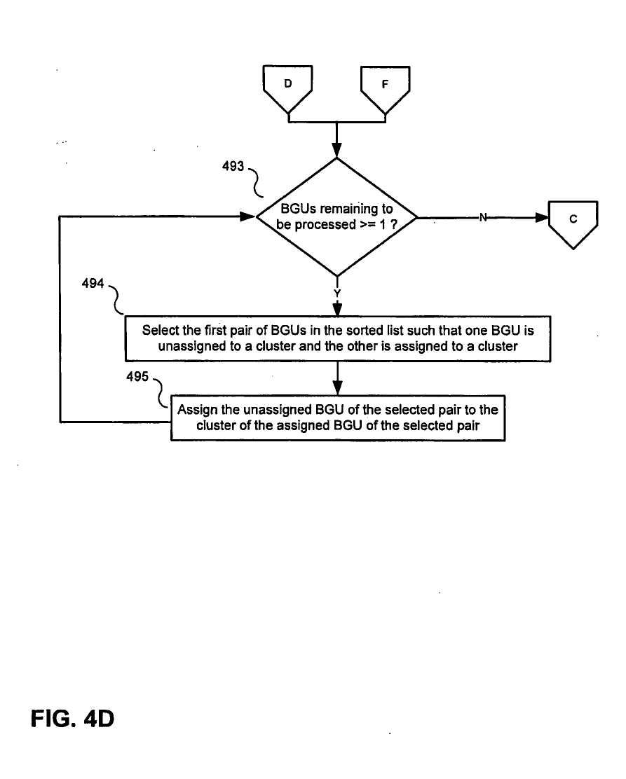

FIG. 4 is a high-level flow diagram illustrating clustering processing in accordance with an embodiment of the present invention. Typically, clustering is performed on the basis of a function of one or more attributes of the properties or transactions at issue. In one embodiment, the process is run once for each county-property type combination. Notably, however, the clustering variable, criteria or function may be other than property type. For example, a clustering function may be based on any attribute, characteristic or combination thereof in relation to a property or transaction. For purposes of the present example, only a single iteration of the clustering process is described for a clustering criterion.

At block 410, all BGUs are sorted by the number of transactions satisfying the specified clustering criterion. In one embodiment, the BGUs are Census Tracts, which may be sorted in descending order in a county by the number of transactions on a single property type. In one embodiment, if the total number of transactions for all BGUs meeting the specified clustering criterion is less than a particular threshold, then all transactions may be assigned to a single segment and the clustering process terminated.

In one embodiment, the threshold may be two times the clustering threshold, e.g., the desired minimum number of transactions within each segment.

At block 415, assuming the clustering process is to proceed, all possible pairs of BGUs are sorted by a similarity function. In one embodiment, all possible pairs of CTs in county are sorted in ascending order by Euclidean Distance (ED) calculated against weighted scaled Census Bureau or other numerical statistical attributes of each CT.

At decision block 420, it is determined whether there is only one BGU remaining to be assigned to a cluster. If not, processing branches to off page connector A, which feeds into decision block 435 of FIG. 4B. Otherwise, if this is the last BGU to be assigned, then processing continues to decision block 425.

At decision block 425, it is determined whether the number of transactions remaining to be assigned to a segment is less than the cluster threshold (e.g., the required number of transactions for a single property type in a county). If so, processing branches to block 430, otherwise processing continues via off page connector B, which feeds into decision block 435 of FIG. 4B. It is to be noted that the cluster threshold may be a different number or the same number for different values of the clustering function or for different segments. The cluster threshold, e.g., the minimum number of transactions desired for a segment may be experimentally or statistically determined and may be an input to the clustering process from another part of the system. As indicated above, a minimum sized segment may be determined that maintains desired accuracy, reliability, precision and/or usefulness of a modeling task. For example, a minimum required number of sample transactions may be established for a segment by making models on successively smaller sets of training data and noting at what set size the accuracy and/or precision of the models begins to degrade or falls below the desired values. The cluster threshold may then be set comfortably above that number of transactions.

At decision block 430, it has been determined that the last BGU is being processed and that the number of remaining transactions falls below the cluster threshold, therefore this final BGU is assigned to the current cluster (or a new cluster if one has yet to be created) and all transactions meeting the current clustering criterion (e.g., being of a particular property type) are assigned to the current segment (or a new segment if one has yet to be created). At this point, clustering processing is complete for the current clustering criterion (e.g., one representative value of a clustering function) and clustering processing may be repeated for other clustering criteria to create segments of appropriate size for other property types, for example.

At decision block 435, it is determined whether the number of transactions remaining to be assigned is equal to the cluster threshold, if so then processing branches to block 440. Otherwise, processing continues with decision block 445.

At block 440, all the remaining BGUs are assigned to the same cluster, all remaining transactions are assigned to the same segment and clustering processing for the current clustering criterion is complete.

At decision block 445, it is determined if the number of BGUs remaining to be processed is greater than zero. If so, the processing continues with decision block 450; otherwise processing for the current clustering criterion is complete.

At decision block 450, the total number of remaining transactions is tested to determine if there is a sufficient number of transactions to make a complete cluster. If there are enough transactions to make a complete cluster, then processing continues with block 455; otherwise processing of this case continues via off page connector D, which feeds into decision block 493 of FIG. 4D.

At block 455, the first unassigned BGU is selected from the sorted list, which in one embodiment, represents the BGU with the largest number of transactions for the current clustering criterion.

At decision block 460, a determination is made regarding whether the number of transactions in the selected BGU is greater than or equal to the cluster threshold. If so, then the BGU is large enough to make up a single cluster and processing continues with block 465; otherwise this block of logic terminates because there are no longer any unassigned BGUs of sufficient size to make up a single cluster and processing branches via off page connector E, which feeds into decision block 470 of FIG. 4C.

At block 465, it has been determined that the selected BGU is of sufficient size to represent its own cluster, therefore the selected BGU is assigned to a single cluster, all transactions associated with the BGU and meeting the current clustering criterion are assigned to a single segment and the counters are decremented (e.g., the total number of remaining transactions is reduced by the number of transactions in the BGU meeting the current clustering criterion and the number of BGUs remaining to be processed is decremented by one).

The case in which the number of transactions remaining is greater than the cluster threshold and the number of transactions in the current BGU is less than the cluster threshold is now described starting with decision block 470.

In the loop represented by blocks 470 to 492, all remaining BGUs are smaller than the cluster threshold, therefore according to the present example, unassigned pairs of BGUs having the most similarity among remaining pairs of unassigned BGU are first assigned to a new cluster and additional BGUs are assigned to the cluster based on their similarity to a BGU already in the cluster.

At decision block 470, it is determined whether the number of BGUs remaining to be processed is greater than or equal to one. If so, then processing continues with decision block 475; otherwise processing terminates for the current clustering criterion.

At decision block 475, the number of transactions remaining is tested against the cluster threshold. If the number of transactions remaining is greater than or equal to the cluster threshold, then processing continues with block 480; otherwise processing branches to off page connector F, which feeds into decision block 493 of FIG. 4D.

At block 480, a new cluster of BGUs is initialized. In one embodiment, various counters/variables may be maintained on a global, per cluster and per segment basis. In such embodiments, at this point in the processing, appropriate counters/variables are set to their initial values.

At block 485, the first pair of BGUs is selected from the list sorted in descending order by a similarity function meeting the condition that both BGUs in the selected pair are currently unassigned to a cluster. In one embodiment, the similarity function is a Euclidean distance calculation involving a distance measurement between the two BGUs in N-dimensional space represented by N numerical attributes. In other embodiments, various other similarity functions may be used to determine how close in N-dimensional space the BGUs are. For example, Mahalanobis distance or Chi-2 distance may be used.

At block 490, both BGUs in the selected pair of BGUs are assigned to the new cluster, all transactions in the BGUs meeting the current clustering criterion are assigned to the new segment and the counters are updated (e.g., BGUs to be processed decremented by two, transactions to be processed reduced by the number just assigned to the new segment, etc.)

At decision block 491, a test is performed to see if the current cluster is complete by comparing the number of transactions in the current cluster to the cluster threshold. If the number of transactions in the current cluster is less than the cluster threshold, then processing continues with block 492 to continue to build the current cluster. Otherwise, the cluster is of sufficient size to be considered complete and processing branches to decision block 470 to determine the clustering process is to be terminated, if a new cluster is to be started or if the remaining transactions need to be assigned to the current cluster.

At block 492, the current cluster has not yet reached the cluster threshold. The first pair of BGUs is selected from the list sorted in descending order by the similarity function meeting the condition that one BGU of the pair is unassigned to a cluster and the other is assigned to the current cluster. Then, processing continues to loop among blocks 490 and 491 incrementally assigning new BGUs to the current cluster until the cluster achieves the cluster threshold.

The case in which the number of transactions remaining is less than or equal to the cluster threshold is now described starting with decision block 493.

In the loop represented by blocks 493 to 495, there are some BGUs that are unassigned, but the total number of transactions in the remaining BGUs is insufficient to populate another complete cluster. According to the present example, the remaining BGUs are processed in a single loop which runs through all the remaining BGUs and assigns them to the most similar clusters that are already complete.

At decision block 493, it is determined if the number of BGUs remaining to be processed is greater than or equal to one. If so, processing continues with block 494; otherwise the clustering process is complete.

At block 494, the first pair of BGUs is selected from the list sorted in descending order by the similarity function meeting the condition that one BGU of the pair is unassigned and the other is assigned to a cluster.

At block 495, the unassigned BGU of the selected pair is assigned to the cluster to which the other is assigned and processing continues with decision block 493 until all the remaining BGUs are assigned to clusters.

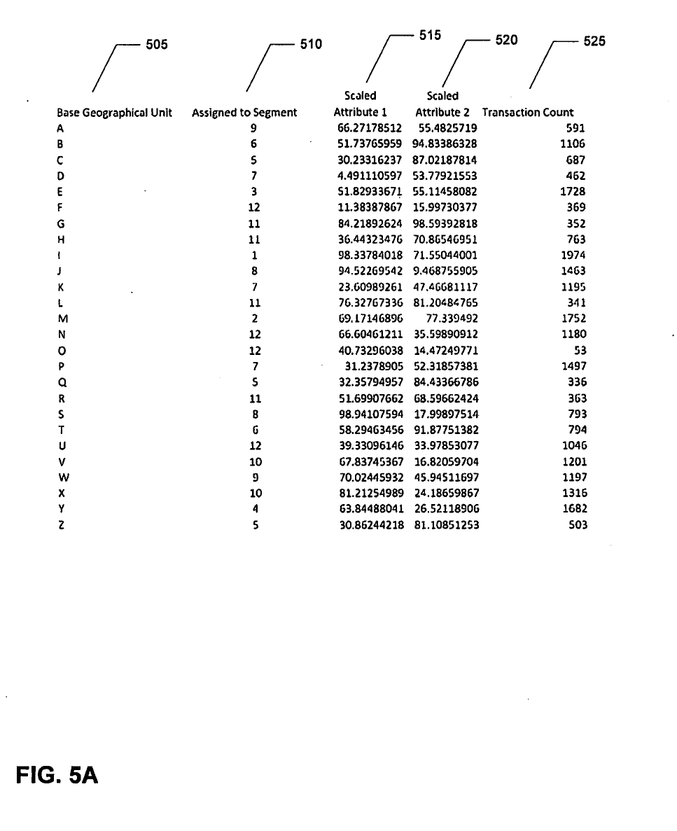

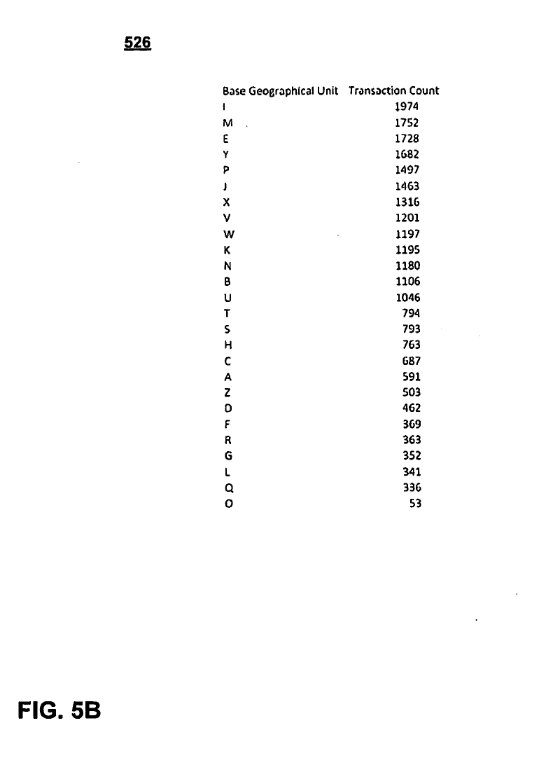

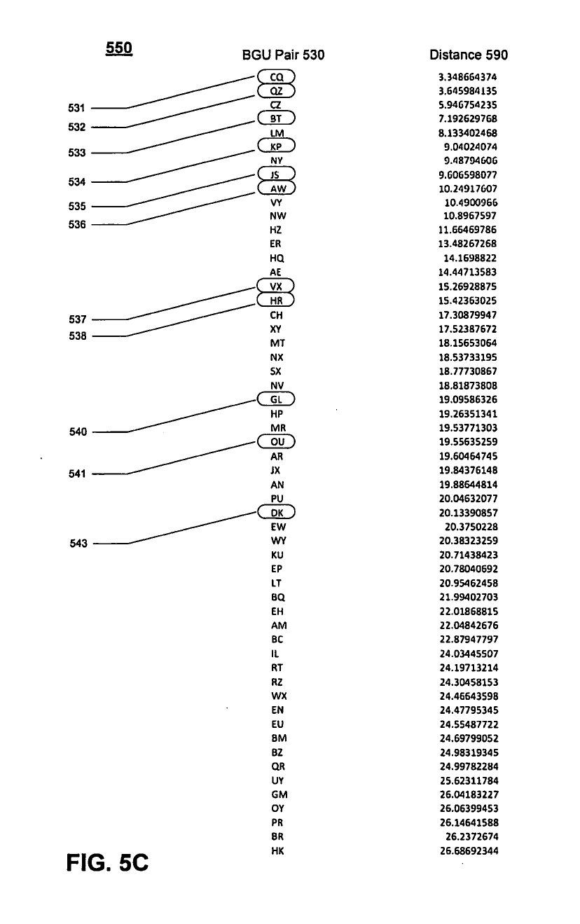

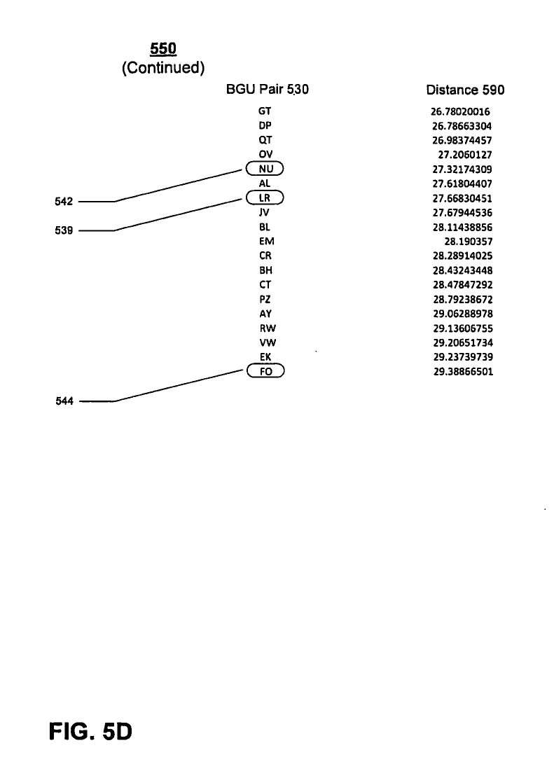

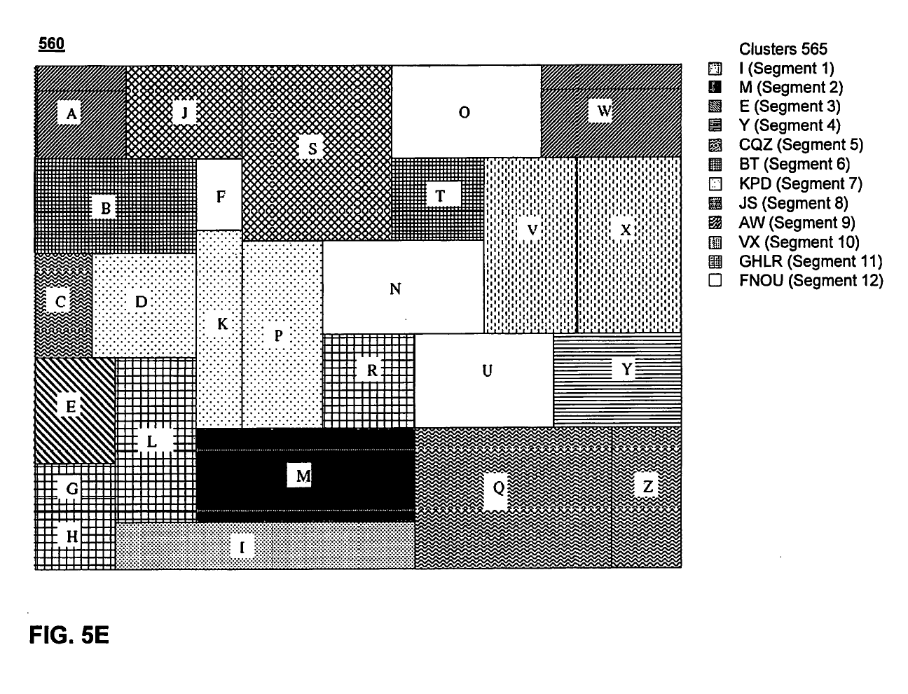

To further illustrate the clustering process illustrated by FIG. 4, a simplified, concrete example is provided below with reference to FIG. 5A. In FIG. 5A, twenty-six BGUs 505 (e.g., Census Tracts) are clustered to create twelve segments 510 each having at least one thousand five hundred transactions for the current clustering criterion (e.g., a particular property type). Each BGU 505 has a scaled value for two numerical attributes 515 and 520. It should be recognized that the clustering methodologies described herein may be used for any number of numerical attributes (examples of which are provided below); however, for sake of brevity, two attributes are used. In the attached Appendix, a step-by-step tracking is provided for various variables, e.g., total assigned BGUs, total remaining BGUs, total assigned transactions and total remaining transactions, which may be maintained in accordance with some embodiments.

Returning to the present example, each BGU 505 also has a number of transactions 525 associated with the current clustering criterion. In the present example, segment numbers are assigned to groups of transactions in the order that the segments are created. Depending upon the particular implementation unique segment IDs may be preferable.

Continuing with the current example, at block 410 all BGUs 505 are sorted by the number of transactions satisfying the specified clustering criterion. The result of this sort in descending order by transaction count is shown in FIG. 5B by list 526. As can be seen with reference to list 526, assuming the cluster threshold, e.g., minimum number of transactions in a segment, is 1500 for purposes of this example, BGUs I, M, E and Y each have a sufficient number of transactions meeting the specified clustering criterion to represent a complete segment.

At block 415, all possible pairs of BGUs are sorted by a similarity function. With 26 BGUs, the total number of pair combinations is 325. For sake of brevity, a subset of the total possible pairs of BGUs is presented in list 550 (spanning FIG. 5C and FIG. 5D), which represents the 75 BGU pairs having the smallest Euclidean distance in the 2-dimensional space represented by the two attributes 515 and 520.

According to the clustering process of FIG. 4, any unassigned BGU with transaction counts greater than the cluster threshold (in this example 1500) are initially assigned to their own segment. Thus, looking at list 526, it can be seen that the transactions of BGUs I, M, E and Y will be assigned to their own segments, segments 1, 2, 3 and 4, respectively.

According to the clustering process of FIG. 4, after the assignment of BGUs having transaction counts greater than the cluster threshold, a BGU pair is selected from the sorted list of BGU pairs 550 in which neither BGU of the pair has been assigned to a cluster. In the current example, this step would cause BGU pair CQ 531 to be selected and their transactions assigned to a new segment (segment 5).

Since the number of transactions for the current segment is less than the cluster threshold (i.e., 1500), another pair of BGUs is selected from the sorted list of BGU pairs 550 such that one BGU is unassigned and the other is assigned to the current cluster. In the present example, this would cause BGU pair QZ 532 to be selected (as Q is in the current cluster and Z is yet to be assigned). Z is then assigned to the current cluster and all the transactions in Z are assigned to the current segment (segment 5). At this point, the number of transactions associated with segment 5 is greater than the cluster threshold. Consequently, the current cluster is complete.

At this point in the clustering process, the number of unassigned BGUs remains greater than one and the total number of unassigned transactions is greater than the cluster threshold. Therefore in accordance with the clustering process of FIG. 4, a new cluster is started by selecting the first pair of BGUs from the sorted list of BGU pairs 550 such that neither BGU is already assigned to a cluster. According to the present example, this step results in BGU pair BT 533 being selected. Since BGUs B and T together have greater than 1500 transactions, they form a complete cluster and all of their transactions are assigned to a single segment (segment 6).

Again, at this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair KP 534 being selected. Since BGUs K and P together have greater than 1500 transactions, they form a complete cluster and all of their transactions are assigned to a single segment (segment 7).

Again, at this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair JS 535 being selected. Since BGUs J and S together have greater than 1500 transactions, they form a complete cluster and all of their transactions are assigned to a single segment (segment 8).

Again, at this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair AW 536 being selected. Since BGUs A and W together have greater than 1500 transactions, they form a complete cluster and all of their transactions are assigned to a single segment (segment 9).

Again, at this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair VX 537 being selected. Since BGUs V and X together have greater than 1500 transactions, they form a complete cluster and all of their transactions are assigned to a single segment (segment 10).

Again, at this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair HR 538 being selected, assigned to a cluster and their transactions assigned to a segment (segment 11).

Since the number of transactions for the current segment (segment 11) is less than the cluster threshold, another pair of BGUs is selected from the sorted list of BGU pairs 550 such that one BGU is unassigned and the other is assigned to the current cluster. In the present example, this would cause BGU pair LR 539 to be selected (as R is in the current cluster and L is yet to be assigned). L is then assigned to the current cluster and all the transactions in L are assigned to the current segment (segment 11). At this point, the number of transactions associated with the current segment (segment 11) is still less than the cluster threshold. Consequently, another pair of BGUs is selected from the sorted list of BGU pairs 550 such that one BGU is unassigned and the other is assigned to the current cluster. In the present example, this would cause BGU pair GL 540 to be selected (as L is in the current cluster and G is yet to be assigned). G is then assigned to the current cluster and all the transactions in G are assigned to the current segment (segment 11). At this point, the number of transactions associated with the current segment (segment 11) is greater than the cluster threshold. Consequently, the current cluster is complete.

At this point in the clustering process, the number of unassigned BGUs remains greater than one and the total number of unassigned transactions is greater than the cluster threshold. Therefore, in accordance with the clustering process of FIG. 4, a new cluster is started by selecting the first pair of BGUs from the sorted list of BGU pairs 550 such that neither BGU is already assigned to a cluster. According to the present example, this step results in BGU pair OU 541 being selected, assigned to a cluster and their transactions assigned to a segment (segment 12).

Since the number of transactions for the current segment (segment 12) is less than the cluster threshold, another pair of BGUs is selected from the sorted list of BGU pairs 550 such that one BGU is unassigned and the other is assigned to the current cluster. In the present example, this would cause BGU pair NU 542 to be selected (as U is in the current cluster and N is yet to be assigned). N is then assigned to the current cluster and all the transactions in N are assigned to the current segment (segment 12). At this point, the number of transactions associated with the current segment (segment 12) is greater than the cluster threshold. Consequently, the current cluster is complete.

At this point in the clustering process, the total unassigned transactions is less than the clustering threshold (i.e., there are not enough remaining transactions to build a complete segment). Therefore, the remaining BGUs (i.e., D and F), in accordance with the clustering processing of FIG. 4, are assigned to existing clusters and their transactions to existing segments.

The first occurrence of BGU D in the sorted list of BGU pairs 550 is selected in which the other BGU in the pair is already assigned. In the present example, this would cause BGU pair DK 543 to be selected (as K has already been assigned to a cluster and its transactions have already been assigned to a segment (segment 7)). D is then assigned to the cluster to which K was previously assigned and all the transactions in D are assigned to the segment (segment 7) to which K's transactions were previously assigned.

Next, the first occurrence of BGU F in the sorted list of BGU pairs 550 is selected in which the other BGU in the pair is already assigned. In the present example, this would cause BGU pair FO 544 to be selected (as O has already been assigned to a cluster and its transactions have already been assigned to a segment (segment 12)). F is then assigned to the cluster to which O was previously assigned and all the transactions in F are assigned to the segment (segment 12) to which O's transactions were previously assigned.

Finally, since the total unassigned transactions is now equal to zero and the unassigned BGUs equals zero, the clustering process to build segments for the current clustering criterion is complete.

FIG. 5E graphically illustrates the results of the clustering process as applied to the sample BGU data of FIG. 5A in accordance with an embodiment of the present invention. In the present example, a county 560 is divided into a number of BGUs (e.g., CTs). Based on their similarity and numbers of transactions meeting the clustering criterion, twelve clusters 565 of BGUs and twelve corresponding segments (segments 1-12) containing the transactions of the clustered BGUs have been created by the clustering processing of FIG. 4. In order to meet the desired cluster threshold of 1500 transactions per segment and based on the similarity of their attributes, BGUs C, Q and Z have been assigned to a cluster and all of their transactions have been assigned to a segment (segment 5). Similarly, BGUs B and T have been clustered to create segment 6, BGUs K, P and D have been clustered to create segment 7, BGUs J and S have been clustered to create segment 8, BGUs A and W have been clustered to create segment 9, BGUs V and X have been clustered to create segment 10, BGUs G, H, L and R have been clustered to create segment 11 and BGUs F, N, O and U have been clustered to create segment 12. Meanwhile, BGUs I, M, E and Y had a sufficient number of transactions to stand on their own as independent segments.

Notably, in the present example, clusters need not be geographically continuous in nature and clusters do not cross county boundaries. For example, in the cluster containing BGUs G, H, L and R, BGU R is not adjacent to any of the other BGUs in the cluster. In alternative embodiments, the clustering processing of FIG. 4 may be modified to include a requirement that each BGU in a cluster is adjacent to at least one other BGU in the cluster. Meanwhile, to the extent counties can be relied on to track data regarding like attributes in a consistent manner, in alternative embodiments, clusters could be allowed to include BGUs from more than one county.

Exemplary Numerical Attributes that may be Associated with BGUs

Depending upon the numerical modeling and/or analysis at issue, in addition to others, various of the following numerical attributes may be associated with BGUs:
ID
DATA
LONGITUDE
LATITUDE
County
State
Name
Population
Male
Female
Age <5
Age 5 to 9
Age 10 to 14
Age 15 to 19
Age 20 to 24
Age 25 to 34
Age 35 to 44
Age 45 to 54
Age 55 to 59
Age 60 to 64
Age 65 to 74
Age 75 to 84
Age 85+
Median Age
Age 18+
Male 18+
Female 18+
Age 21+
Age 62+
Age 65+
Male 65+
Female 65+
InHouseholds
InHH_Householder
InHH_Spouse
InHH_Child
InHH_Own Child_Age <18
InHH_Other Relatives
InHH_Other_Age <18
InHH_Nonrelative
InHH_Unmarried Partner
In group quarters
InGrp_Institutionalized
InGrp_Noninstitutionalized
Households
HH_Family
HH_Family_Own Child <18
HH_Family Married
HH_Family_Mar_Own Child<18
HH_Female No Husband
HH_Female_Own Child<18
HH_Nonfamily
HH_Non_Living Alone
HH_Non_Alone_HHer 65+
HH_People <18
HH_People 65+
Average HH Size
Average Family Size
Housing Units
HU_Occupied
HU_Vacant
VacHU_For Seasonal Use
Owner Vacancy Rate
Rental Vacancy Rate
OccHU_Owner Occupied
OccHU_Renter Occupied
OccHU_Own_Avg HH Size
OccHU_Rent_Avg HH Size
In school 3+
In Sch_Nursery/preschool
In Sch_Kindergarten
In Sch_Elementary
In Sch_High school
In Sch_College/grad school
Population 25+
25+_{—}<9th grade
25+_{—}9th to 12th grade no diploma
25+_High school grad
25+_Some college no degree
25+_Associate degree
25+_Bachelor's degree
25+_Grad or prof degree
25+_% HS grad or higher
25+_% bachelor's degree or higher
Population 15+
15+_Never married
15+_Now married
15+_Separated
15+_Widowed
15+_Widowed_Female
15+_Divorced
15+_Divorced_Female
Grandparent in HH_w/own grandchild <18
Grandparent resp for grandchildren <18
Civilian 18+
Civilian 18+_Veterans
Population 5-20
Population 65+
Population 5+
5+_Same house in 1995
5+_Different house in 1995
5+_Diff hse_Same county
5+_Diff hse_Diff county
5+_Diff hse_Diff co_Same state
5+_Diff hse_Diff co_Diff state
5+_Elsewhere in 1995
Population 16+
16+_In labor force
16+_In LF_Civilian
16+_In LF_Civilian-Employed
16+_In LF_Civilian_Unemployed
16+_In LF_Civilian_Unempl_%
16+_In LF_Armed Forces
16+_Not in labor force
Females 16+
Fem 16+_In labor force
Fem 16+_In LF_Civilian
Fem 16+_In LF_Civilian_Employed
Own children<6
Own child<6_All parents in LF
Workers 16+
16+_Mode: Car_Drove alone
16+_Mode: Car_Carpooled
16+_Mode: Public trans
16+_Mode: Walked
16+_Mode: Other means
16+_Mode: Worked at home
16+_Mean travel time to work
Employed civilian population 16+
EC 16+_Occ: Manage/prof
EC 16+_Occ: Service
EC 16+_Occ: Sales/office
EC 16+_Occ: Farming/fishing/forestry
EC 16+_Occ: Constr/extract/maint
EC 16+_Occ: Prod/transp/material
EC 16+_Ind: Ag/forestry/fishing/mining
EC 16+_Ind: Construction
EC 16+_Ind: Manufacturing
EC 16+_Ind: Wholesale trade
EC 16+_Ind: Retail trade
EC 16+_Ind: Transportation/warehousing
EC 16+_Ind: Information
EC 16+_Ind: Finance/ins/RE/rental
EC 16+_Ind: Prof/scientific/admin
EC 16+_Ind: Ed/health/soc services
EC 16+_Ind: Art/entertain/rec/acc/food
EC 16+_Ind: Other (ex public admin)
EC 16+_Ind: Public administration
EC 16+_Workers: Private wage/salary
EC 16+_Workers: Government
EC 16+_Workers: Self-employed
EC 16+_Workers: Unpaid family
Households (LF)
HH_Income <$10K
HH_Income $10K-14999
HH_Income $15K-24999
HH_Income $25K-34999
HH_Income $35K-49999
HH_Income $50K-74999
HH_Income $75K-99999
HH_Income $100K-149999
HH_Income $150K-199999
HH_Income $200K+
HH_Median income
HH_w/earnings
HH_w/earnings_Mean earnings
HH_w/Social Security income
HH_w/SS_Mean income
HH_w/Supplemental Security Income
HH_w/SSI_Mean income
HH_w/public assistance income
HH_w/PA_Mean income
HH_w/retirement income
HH_w/ret_Mean income
Families (LF)
Fam_Inc: <$10K
Fam_Inc: $10K-$14999
Fam_Inc: $15K-$24999
Fam_Inc: $25K-$34999
Fam_Inc: $35K-$49999
Fam_Inc: $50K-$74999
Fam_Inc: $75K-$99999
Fam_Inc: $100K-$149999
Fam_Inc: $150K-$199999
Fam_Inc: $200K+
Fam_Median family income
Fam_Per capita income
Fam_Median earnings_Male FT
Fam_Median earnings_Female FT
Below pov lev: Families
Below pov lev: Fam-w/rel child <18
Below pov lev: Fam-w/rel child <5
Below pov lev: Fam w/fem Hher no husb
Below pov lev: Fem HHer_rel chld<18
Below pov lev: Fem HHer_rel child<5
Below pov lev: Individuals
Below pov lev: Indiv_{—}18+
Below pov lev: Indiv_{—}65+
Below pov lev: Indiv_Rel child <18
Below pov lev: Indiv_Rel child 5-17
Below pov lev: Indiv_Unrelated 15+
Pov stat det: Families
Pov stat det: Fam-w/rel child <18
Pov stat det: Fam-w/rel child <5
Pov stat det: Fam w/fem Hher no husb
Pov stat det: Fem HHer_rel chld<18
Pov stat det: Fem HHer_rel child<5
Pov stat det: Individuals
Pov stat det: Indiv_{—}18+
Pov stat det: Indiv_{—}65+
Pov stat det: Indiv_Rel child<18
Pov stat det: Indiv_Rel child 5-17
Pov stat det: Indiv_Unrelated 15+
HU_{—}1 unit detached
HU_{—}1 unit attached
HU_{—}2 units
HU_{—}3-4 units
HU_{—}5-9 units
HU_{—}10-19 units
HU_{—}20+units
HU_Mobile home
HU_Boat/RV/van
HU_Built 1999-March 2000
HU_Built 1995-1998
HU_Built 1990-1994
HU_Built 1980-1989
HU_Built 1970-1979
HU_Built 1960-1969
HU_Built 1940-1959
HU_Built 1939 or earlier
HU_{—}1 room
HU_{—}2 rooms
HU_{—}3 rooms
HU_{—}4 rooms
HU_{—}5 rooms
HU_{—}6 rooms
HU_{—}7 rooms
HU_{—}8 rooms
HU_{—}9+rooms
HU_Median rooms
OccHU_Moved in: 1999-March 2000
Occ HU_Moved in: 1995-1998
Occ HU_Moved in: 1990-1994
Occ HU_Moved in: 1980-1989
Occ HU_Moved in: 1970-1979
Occ HU_Moved in: 1969 or earlier
Occ HU_No vehicles
Occ HU_{—}1 vehicle
Occ HU_{—}2 vehicles
Occ HU_{—}3+vehicles
Occ HU-Utility gas
Occ HU_Bottled/tank/LP gas
Occ HU_Electricity
Occ HU_Fuel oil/kerosene
Occ HU_Coal/coke
Occ HU_Wood
Occ HU_Solar energy
Occ HU_Other fuel
Occ HU_No fuel used
Occ HU_Lacking complete plumbing
Occ HU_Lacking complete kitchen
Occ HU_No telephone service
Occ HU_Occ/room: 1 or less
Occ HU_Occ/room: 1.01-1.5
Occ HU_Occ/room: 1.51+
Specified owner-occupied units
Sp own-occ_Value: <$50K
Sp own-occ_Value: $50K-99999
Sp own-occ_Value: $100K-149999
Sp own-occ_Value: $150K-199999
Sp own-occ_Value: $200K-299999
Sp own-occ_Value: $300K-499999
Sp own-occ_Value: $500K-999999
Sp own-occ_Value: $1000000+
Sp own-occ_Value: Median
Sp own-occ_With a mortgage
Sp own-occ_w/mortgage<$300
Sp own-occ_w/mortgage_$300-499
Sp own-occ_w/mortgage_$500-699
Sp own-occ_w/mortgage_$700-999
Sp own-occ_w/mortgage_$1K-1499
Sp own-occ_w/mortgage_$1.5K-1999
Sp own-occ_w/mortgage_$2K+
Sp own-occ_Median cost
Sp own-occ_Not mortgaged
Sp own-occ_Not mort_Median cost
Sp own-occ_Costs<15% of HH inc
Sp own-occ_Costs 15-19% of HH inc
Sp own-occ_Costs 20-24.9% of HH inc
Sp own-occ_Costs 25-29.9% of HH inc
Sp own-occ_Costs 30-34.9% of HH Inc
Sp own-occ_Costs 35+% of HH Inc
Sp own-occ_Costs_Not computed
Specified renter-occupied units
Sp rent-occ_Rent <$200
Sp rent-occ_Rent $200-299
Sp rent-occ_Rent $300-499
Sp rent-occ_Rent $500-749
Sp rent-occ_Rent $750-999
Sp rent-occ_Rent $1000-1499
Sp rent-occ_Rent $1.5K+
Sp rent-occ_No cash rent
Sp rent-occ_Median rent
Sp rent-occ_Rent <15% of HH Inc
Sp rent-occ_Rent 15-19.9% of HH Inc
Sp rent-occ_Rent 20-24.9% of HH Inc
Sp rent-occ_Rent 25-29.9% of HH Inc
Sp rent-occ_Rent 30-34.9% of HH Inc
Sp rent-occ_Rent 35+% of HH Inc
Sp rent-occ_Rent not computed

Additional Exemplary Numerical Attributes that may be Associated with BGUs

Depending upon the numerical modeling and/or analysis at issue, the following additional attributes may also be associated with BGUs. However, in various contexts, such as in connection with making lending decisions by lending institutions, it may be desirable to exclude use of the following numerical attributes to obviate any inference of redlining.
1 Race
White

Black
AmIndian
Asian
Asn_Asian Indian
Asn_Chinese
Asn_Filipino
Asn_Japanese
Asn_Korean
Asn_Vietnamese
Asn_Other Asian
Hawaiian
Hwn_Native
Hwn_Guamanian
Hwn_Samoan
Hwn_Other PI
Other Race
2+ Races
AP White
AP Black
AP AmIndian
AP Asian
AP Hawaiian
AP_Other
AP_Hispanic Origin
H_AP Mexican
H_AP Puerto Rican
H_AP Cuban
H_AP Other
Not Hispanic
NH_White
21-64_w/disability_% employed
21-64_No disability
21-64_No disability_% employed
65+_w/disability
Native
Native_Born in US
Native_Born in US_Res State
Native_Born in US_Diff State
Native_Born outside US
Foreign
Foreign_Entered 1990-March 2000
Foreign_Naturalized citizen
Foreign_Not a citizen
Foreign born (ex born at sea)
Foreign_Europe
Foreign_Asia
Foreign_Africa
Foreign_Oceania
Foreign_Latin America
Foreign_Northern America
5+_English only
5+_Other language
5+_Other lang_Engl <very well
5+_Other lang_Spanish
5+_Other lang_Sp_Engl <very well
5+_Other Indo-European
5+_Other lang_Indo-Eur Engl <very well
5+_Other lang_Asian and Pacific Island
5+_Other lang_API_Engl <very well
Total ancestries reported
Ancestry_Arab
Ancestry_Czech
Ancestry_Danish
Ancestry_Dutch
Ancestry_English
Ancestry_French (ex Basque)
Ancestry_French Canadian
Ancestry_German
Ancestry_Greek
Ancestry_Hungarian
Ancestry_Irish
Ancestry_Italian
Ancestry_Lithuanian
Ancestry_Norwegian
Ancestry_Polish
Ancestry_Portuguese
Ancestry_Russian
Ancestry_Scotch-Irish
Ancestry_Scottish
Ancestry_Slovak
Ancestry_Subsaharan African
Ancestry_Swedish
Ancestry_Swiss
Ancestry_Ukrainian
Ancestry_US or American
Ancestry_Welsh
Ancestry West Indian (ex Hisp)
Ancestry_Other ancestries 5-20_w/disability 21-64_w/disability
Having now described various clustering methodologies, provided examples of various numerical attributes and walked through a simple concrete example, use of the clustered real estate transaction data in the context of exemplary numerical modeling and/or analysis (e.g., estimating real property valuations) will now be described.

According to one embodiment, a real property valuation process begins when a case, consisting of a property data record, is initiated by a user as a request for valuation. The request might include any data that uniquely identifies the desired property including, for example, the street address, city, state and ZIP Code, or the assessor's parcel number or the name of the owner and the city, state and ZIP Code, or the owner and ZIP Code.

If the case is part of a list (batch) of such requests submitted at the same time, then each property on the list can have a user defined unique identifier to assist the user in identifying individual cases in the output report. According to one embodiment, these requests can be initiated from outside the system using a World Wide Web based user interface, UI, which is only accessible by means of a login.

After completing the login by entering a username and password, the user may be directed to a page that allows initiation of a case and is presented with a number of tabs including in this embodiment “Find”, “My Work”, “Batch Jobs”, “Advanced”, “Search”, “Admin”, “iMVI” and “Alerts”, access to each of these tabs require a set of permissions that are administered within the functionality of the “Admin” tab.

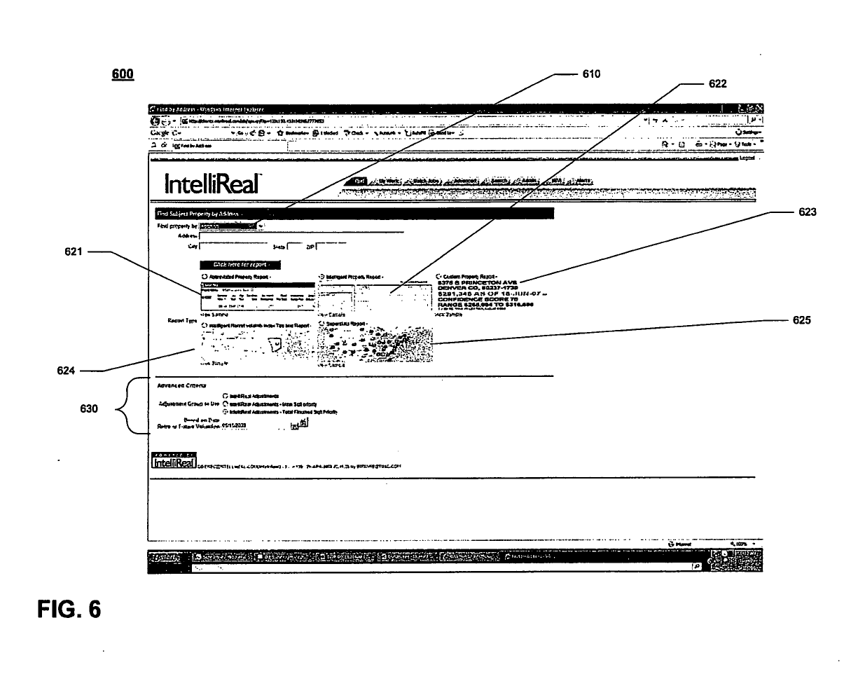

For purposes of providing an understanding of the valuation process, the “Find” tab, shown in FIG. 6 is described. FIG. 6 is a user interface screen shot of a page 600 that may assist with property identification in accordance with an embodiment of the present invention. According to the present example, the user can select the method of property identification from among, “Address”, “Owner” or “House Number and Street Name” by means of a drop down select box 610. Each selection updates the page 600 with fill in boxes appropriate to the method selected by the user. The method selected for illustration is the “Address” method. The user enters the street address, including unit number, if required to uniquely identify the property, the city, state and ZIP Code. If the information is incomplete the system can nevertheless still process the request as long as enough information is provided. The user can also select a number of reports including “Abbreviated Property Report” 621, “Intelligent Property Report” 622, “Custom Property Report” 623, “Intelligent Market Volatility Index” 624 or “Superstats Report” 625. Each of these selections provides information about the case initiated. In the “Advanced Criteria” area 630 the user can also select from among a number of adjustment schemes appropriate to the needs of the user of the user together with the past, present or future date of the value of the property. For purposes of this example, an “Intelligent Property Report” is requested using the “IntelliReal Adjustments—Total Finished Sqft Priority” and May 15, 2008 as the “Based on Date Retro or Future Valuation” entry.

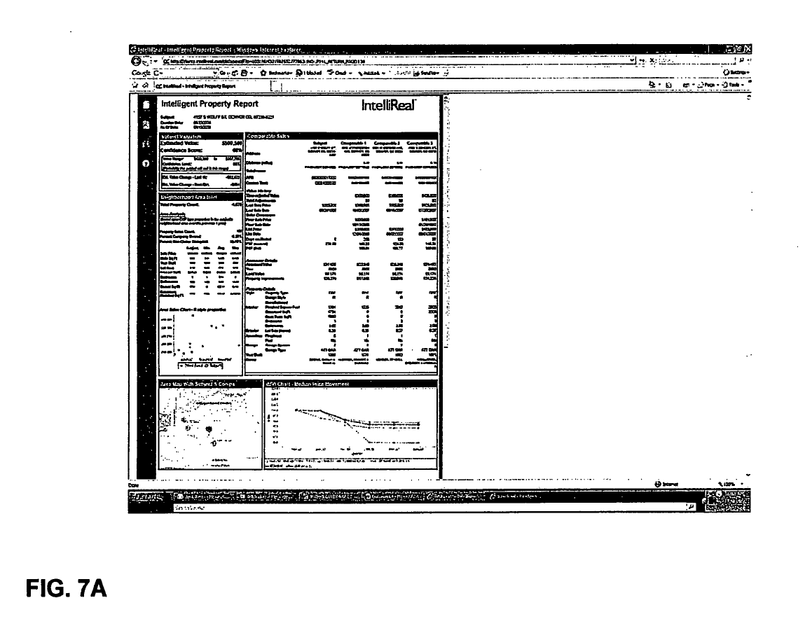

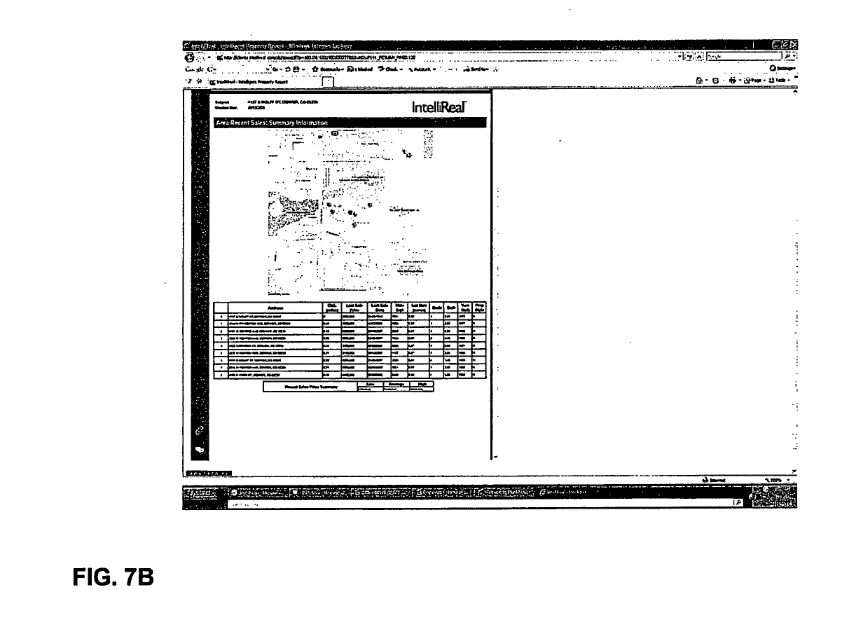

After the report is initiated the database calculates a valuation and assembles a default set of statistics, charts, maps, lists of comparable properties with adjustments, etc. One possible output exemplary among various possible outputs is shown by FIGS. 7A and 7B.

FIG. 7 is an Intelligent Property Report for a subject property in accordance with an embodiment of the present invention. In the present example, only a portion of the report is shown for illustration. Information included in the report includes:

Report information including the Subject Property standardized address, the Creation Date of the report, the As of Date of the valuation;

Subject Valuation information including the Estimated Value of the Subject Property the Confidence Score of the valuation, a confidence interval represented as the range of values that the bracket the Estimated Value at a displayed confidence level, the Estimated Value Change in the Last Year and the Future Quarter.

A table of Comparable Property Sales side-by-side with the subject showing the Distance between the subject and each comparable property, the Subdivision Names, the Value History of each property including Time-adjusted Value, Total Adjustment, Last Sale Price, Last Sale Date, Seller Concession, Prior Sale Price, Prior Sale Date, MLS List Price, MLS List Date, Days on Market, PSF (Current), PSF (list), and Assessor Details including: Tax Value, Year, Land Value, and Property Improvements; Property Details including Style information including: Property Type, Design Style, Stories, Manufactured, Number of Units; Interior Details including: Finished SqFt, Basement SqFt, Bsmt Fnsh SqFt, Bedrooms, Bathrooms; Exterior including: Lot Size (acres), Amenities including: Fireplaces, Pool; Garage information including: Garage Spaces, Garage Type; Year Built, Owner.

Neighborhood Area Intel, segment data including: Total Property Count; and Area Analysis including: Property Sales Count, Percent Company Owned, Percent Non-Owner Occupied; a table showing Subject, Min, Avg, and Max statistics including: Sales Price, Main Sq Ft, Year Built, Lot Area, Price per Sq Ft, Bedrooms, Bathrooms, Basement Sq Ft, Basement Finished Sq Ft for the Neighborhood (segment); and an Area Sales Chart showing sales over time by prices as a scatter plot.

Area Map With Subject & Comps, which is displayed on an area street or hybrid map the location of the Subject Property and each of the comparable properties.

IMVI Chart—Median Price Movement for the Segment, County, MSA, State, and the Nation showing indexed trend lines for each.

This is followed by an “Area Recent Sales: Summary Information” that lists all nearby sales over the past year and property details including a list position number, Address, Distance (miles), Sale Price, Sale Date, Main Sqft, Lot Size, Bedrooms, Bathrooms, Year Built and Property Style for each. This is followed by another map which shows each of the sales in the list in its proper location relative to the Subject Property as an icon with the list position number in the center.

In one embodiment, the actual reports displayed on the exemplary “Intelligent Property Report” are user customizable from a dropdown table in on the report page. The choices include: IPR, Area Recent Sales Report (with map), Comp Stats Report, MLS Details Report, Active Area Listings Report (with map), Competitive Market Climate Report (Saturation Report), Neighborhood Stats Report, Nearby Sales Report (with map), Market Summary Report.

In alternative embodiment, the primary method of customer data delivery may be by means of data feeds that are fully customized to client needs.

A high level description of the process of delivering a valuation follows: The property address, for example, is checked to assure that the input information includes a combination of inputs that might allow identification of a property. If the address information does not meet minimum requirements the process terminates with a warning. If the input address meets minimum requirements, it is parsed and the street address, city, state, and ZIP information is completed, if incomplete. Completion consists of finding the ZIP from the city and street information, if the ZIP is missing, or finding the city and/or state information if the city and/or state is missing. This is accomplished by looking up the data in USPS supplied tables. Then, the address is standardized. Standardization first identifies and arranges the address elements in the preferred USPS format and converts pre-directionals and post-directionals (like North) to USPS preferred (like N) and street types (like Avenue) to USPS preferred abbreviations (like AVE). For example 123 North Main Street W Apartment 23, Anytown, Washington would be corrected to 123 N Main St W APT 23, Any Town, WA 99016. The next step is to look up the street address and find a range of addresses that contain the subject address within the ZIP Code within USPS table of address ranges. A successful search allows the assignment of a ZIP four-digit add on. The exemplary address then becomes 123 N Main St W APT 23, Anytown, WA 99016-3221. A succession of iterative searches is sometimes necessary when misspellings of address components and mismatches between city and ZIP are encountered. Once the ZIP+4 Code is appended to the address then the standardized corrected address is compared to the USPS DPV database of deliverable address to find an exact match of street number and if included unit number. If there is no exact match the system takes action based upon the input of the user. The user can choose that a valuation is not returned or that the nearest match is valued or that only neighborhood report information is returned without a valuation.

If the input address is successfully verified, then the input corrected standardized address is found in the system master address file by searching for exact matches with the corrected standardized addresses in the master address file. If the search is successful, the process continues, user settings can allow the data from the closest match to be used.

Once the input address is matched, it is assigned the same primary key as the matched address. This primary key can be used to link to all data in the warehouse concerning the input subject property.

The data warehouse is in continuous operation receiving new data from multiple of sources, transforming and loading the data, testing data integrity, correcting and standardizing addresses, adding new addresses, merging new data with old in individual records, adding records, training and retraining models, testing models, calculating supervisory statistics, geocoding, clustering and segmenting, valuing properties, calculating and capturing the resulting valuations, creating historical records and trends, archiving data and so forth.

In one embodiment, when a valuation is requested, the subject property identified reports, including valuations and ancillary report statistics, are already calculated and only need to be assembled in the desired format.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving information regarding a plurality of real property transactions, each of the plurality of real property transactions corresponding to a base geographic unit of a plurality of base geographic units based on information regarding a physical location of a real property associated with the real property transaction;
for each of a plurality of values of a clustering function represented within the plurality of real property transactions, building a plurality of relatively homogeneous segments of transactions by aggregating transactions of one or more of the plurality of base geographic units into clusters based on application of a predetermined similarity function among corresponding attributes of a plurality of numerically valued attributes associated with the plurality of base geographic units until each segment of the plurality of relatively homogeneous segments has a sufficient number of transactions to provide desired accuracy, reliability or usefulness in the context of desired numerical modeling or analysis and all of the plurality of real property transactions have been assigned to a segment of the plurality of relatively homogeneous segments; and
performing the desired numerical modeling or analysis based on one or more of the plurality of relatively homogeneous segments.

2. The method of claim 1, wherein the desired numerical modeling or analysis comprises estimating an appropriate transfer price of a real property by applying one or more automated real property valuation models to a segment of the plurality of relatively homogeneous segments with which the real property is associated.

3. The method of claim 1, wherein the desired numerical modeling or analysis comprises generating one or more price indices for one or more subsets of the plurality of real property transactions.

4. The method of claim 1, wherein the desired numerical modeling or analysis comprises determining one or more trend lines for the one or more subsets of the plurality of real property transactions.

5. The method of claim 1, wherein the desired numerical modeling or analysis comprises performing fraud detection.

6. A method comprising:
receiving information regarding real property transactions;
assigning each real property transaction to an appropriate base geographic unit of a plurality of base geographic units based on information regarding a physical location of a real property associated with the real property transaction and statistical information either derived from the information or gathered from other sources about the plurality of base geographic units or defined agglomeration of the plurality of base geographic units;
building a plurality of relatively homogeneous segments of real property transactions by aggregating one or more of the plurality of base geographic units into clusters based on application of a predetermined similarity function among corresponding numerically valued attributes associated with the plurality of base geographic units on a property type-by-property type basis until each of the plurality of relatively homogeneous segments is of sufficient size to facilitate one or more of accuracy and precision of one or more automated real property valuation models; and
estimating an appropriate transfer price of a real property by applying the one or more automated real property valuation models to a segment of the plurality of relatively homogeneous segments with which the real property is associated.

7. The method of claim 6, further comprising, assigning those of the plurality of base geographic units having a number of real property transactions meeting or exceeding the sufficient size to individual clusters.

8. The method of claim 7, further comprising:
creating a list of all possible pairs of base geographic units of the plurality of base geographic units sorted by the predetermined similarity function; and
assigning pairs of the plurality of base geographic units from the sorted list to the clusters.

9. The method of claim 8, wherein the information regarding the physical location of the real property associated with the real property transaction comprises a plurality of attributes of the physical location.

10. The method of claim 8, wherein the plurality of base geographic units comprise one of Unites States Postal Service ZIP Codes, ZIP+2 codes, ZIP+4 codes, regions, states, counties, school districts or synthetically generated grids.

11. The method of claim 8, wherein the plurality of base geographic units is created for statistical purposes and statistics are consistently collected regarding the plurality of base geographic units.

12. The method of claim 8, wherein the plurality of base geographic units comprise Census Tracts.

13. The method of claim 12, wherein at least one cluster of the clusters includes geographically discontinuous Census Tracts.

14. The method of claim 12, wherein no cluster of the clusters includes Census Tracts from more than one county.

15. The method of claim 12, wherein the predetermined similarity function comprises Euclidean distance.

16. The method of claim 12, wherein the predetermined similarity function comprises Mahalanobis distance.

17. A method comprising:
receiving information regarding real property transactions;
assigning each real property transaction to an appropriate base geographic unit of a plurality of base geographic units based on information regarding a physical location of a real property associated with the real property transaction;
for each property type of a plurality of property types represented in the real property transactions, creating relatively homogeneous segments of sufficient size to facilitate one or more of accuracy and precision of one or more automated real property valuation models by aggregating one or more of the plurality of base geographic units into a plurality of clusters by applying a predetermined similarity function among corresponding numerically valued attributes of the plurality of base geographic units; and
estimating an appropriate transfer price of a real property by applying the one or more automated real property valuation models to a segment of the relatively homogeneous segments with which the real property is associated.

18. The method of claim 17, further comprising, assigning those of the plurality of base geographic units having a number of real property transactions meeting or exceeding the sufficient size to individual clusters of the plurality of clusters.

19. The method of claim 18, further comprising:
creating a list of all possible pairs of base geographic units of the plurality of base geographic units sorted by the predetermined similarity function; and
assigning pairs of the plurality of base geographic units from the sorted list to the plurality of clusters.

20. The method of claim 18, wherein the information regarding the physical location of the real property associated with the real property transaction comprises a plurality of attributes of the physical location.

21. The method of claim 18, wherein the plurality of base geographic units comprise one of Unites States Postal Service ZIP Codes, ZIP+2 codes, ZIP+4 codes, regions, states, counties, school districts or synthetically generated grids.

22. The method of claim 18, wherein the plurality of base geographic units is created for statistical purposes and statistics are consistently collected regarding the plurality of base geographic units.

23. The method of claim 18, wherein the plurality of base geographic units comprise Census Tracts.

24. The method of claim 23, wherein at least one cluster of the clusters includes geographically discontinuous Census Tracts.

25. The method of claim 23, wherein no cluster of the clusters includes Census Tracts from more than one county.

26. The method of claim 23, wherein the predetermined similarity function comprises Euclidean distance.

27. The method of claim 23, wherein the predetermined similarity function comprises Mahalanobis distance.

28. A method comprising:
receiving information regarding real property transactions;
forming a set of segmented real property transaction data by grouping the real property transactions into segments based on a function of one or more attributes associated with the real property transactions;
assigning each real property transaction of the set of segmented real property transaction data to an appropriate base geographic unit of a plurality of base geographic units based on information regarding a physical location of a real property associated with the real property transaction;
forming a set of segmented and clustered real property transaction data by grouping the plurality of base geographic units into a plurality of clusters by applying a predetermined similarity function among corresponding attributes of a plurality of numerically valued attributes of the plurality of base geographic units on a segment-by-segment basis and requiring each of the segments of clusters have at least a predetermined minimum number of clustered elements which is defined to facilitate one or more of accuracy and precision of one or more automated real property valuation models; and
estimating an appropriate transfer price of a real property associated with a cluster of the plurality of clusters of the plurality of base geographic units by applying the one or more automated real property valuation models to the set of segmented and clustered real property transaction data.

29. The method of claim 28, wherein the information regarding the physical location of the real property associated with the real property transaction comprises a plurality of attributes of the physical location.

30. The method of claim 28, wherein the plurality of base geographic units comprise one of Unites States Postal Service ZIP Codes, ZIP+2 codes, ZIP+4 codes, regions, states, counties, school districts or synthetically generated grids.

31. The method of claim 28, wherein the plurality of base geographic units is created for statistical purposes and statistics are consistently collected regarding the plurality of base geographic units.

32. The method of claim 31, wherein the plurality of base geographic units comprise Census Tracts.

33. The method of claim 32, wherein at least one cluster of the plurality of clusters includes geographically discontinuous Census Tracts.

34. The method of claim 33, wherein no cluster of the plurality of clusters includes Census Tracts from more than one county.

35. The method of claim 32, further comprising preprocessing the information regarding real property transactions including:
establishing the predetermined minimum number of clustered elements by making models on successively smaller sets of training data to determine a size at which the accuracy or the precision of the one or more automated real property valuation models begins to degrade;
identifying suitable transactions by scrubbing the set of example transactions to exclude non-free market transactions;
assigning each of the suitable transactions to a correct Census Tract of a plurality of Census Tracts;
storing statistical data regarding each Census Tract by collecting, weighting and scaling data regarding the suitable transactions; and
for every county and every possible pair of Census Tracts within the county, calculating and recording the predetermined similarity function based on the statistical data.

36. The method of claim 35, wherein the predetermined similarity function comprises Euclidean distance.

37. The method of claim 35, wherein the predetermined similarity function comprises Mahalanobis distance.
